(19) United States
(12) Patent Application Publication
(10) Pub. No.: US 2014/0289595 A1
(43) Pub. Date: Sep. 25, 2014

(54) METHOD AND SYSTEM OF PERFORMING ELECTRONIC APPROVAL PROCESSES AND COMPUTER-READABLE STORAGE MEDIUM STORING ELECTRONIC APPROVAL PROGRAM

(71) Applicants: Young-Woo PARK, Seongnam-si (KR); Dong-Keun KIM, Seoul (KR); Dong-Min JU, Seoul (KR)

(72) Inventors: Young-Woo PARK, Seongnam-si (KR); Dong-Keun KIM, Seoul (KR); Dong-Min JU, Seoul (KR)

(73) Assignee: Young-Woo Park, Seongnam-si (KR)

(21) Appl. No.: 14/222,220

(22) Filed: Mar. 21, 2014

(30) Foreign Application Priority Data
Mar. 22, 2013 (KR) 10-2013-0030808

(51) Int. Cl. G06F 17/24

(52) U.S. Cl. CPC G06F 17/24
USPC 715/202

(57) ABSTRACT

A letter approval item including an approval document is created in an approval requester's PC and the approval document includes a signable region. An approval is requested by transmitting the letter approval item to a database server. A mobile-based approval item including the letter approval item is provided to a web/application server and then to an approver's mobile device when the approver's mobile device requests. The approval of the letter approval item is performed in the approver's mobile device in response to a direct signature of an approver. A signature image is created in the approver's mobile device by the direct signature of the approver. The signature image is transmitted to the web/application server and a final approval document is generated in the web/application server by inserting the signature image in the signable region of the approval document.

### CROSS-REFERENCE TO RELATED APPLICATION

This U.S. Non-provisional application claims priority under 35 USC §119 to Korean Patent Application No. 10-2013-0030808, filed on Mar. 22, 2013, in the Korean Intellectual Property Office (KIPO), the disclosure of which is incorporated by reference in its entirety herein.

### BACKGROUND

1. Technical Field

Example embodiments relate generally to electronic approval, and more particularly to methods and systems of performing electronic approval processes and computer-readable storage media storing an electronic approval program.

2. Discussion of the Related Art

Recently, according to rapid developments of various technologies of electronics, communications, etc., paper documents are being replaced with electronic documents and also electronic systems of processing the electronic documents are being developed.

When an electronic document created by a particular word processor is edited or modified in a mobile device such as a smart phone, a personal digital assistant (PDA), etc. to implement an electronic approval system, the mobile device has to have the editing function of the word processor. Accordingly the mobile device cannot perform the electronic approval processes of the electronic document to be approved when the mobile device has no editing function of the word processor.

To solve such problem, the electronic document may be converted to an image file and the image file may be confirmed and processed by the mobile device using an image viewer program established in the mobile device. In this case, a final approval document may be generated by inserting a pre-stored signature image into the image file.

The pre-stored signature image is not a genuine signature that is drawn by a signer or an approver in real time. Authenticity of signature may be degraded when the same signature image is used in the different documents.

### SUMMARY

At least one example embodiment of the inventive concept provides a method of performing electronic approval processes capable of securing authenticity of signature.

At least one example embodiment of the inventive concept provides a system of performing the electronic approval processes.

At least one example embodiment of the inventive concept provides a computer-readable storage medium storing an electronic approval program.

According to example embodiments, in a method of performing electronic approval processes, a letter approval item including an approval document is created in an approval requester's personal computer (PC), where the approval document includes a signable region. An approval of the letter approval item is requested by transmitting the letter approval item from the approval requester's PC to a database server. Existence of the letter approval item is notified by providing a mobile-based approval item including the letter approval item from the database server to a web/application server. The mobile-based approval item is transmitted from the web/application server to a approver's mobile device when the approver's mobile device asks existence of any approval item to the web/application server. The approval of the letter approval item is performed in the approver's mobile device in response to a direct signature of an approver. A signature image is transmitted from the approver's mobile device to the web/application server, where the signature image is created in the approver's mobile device by the direct signature of the approver. A final approval document is generated in the web/application server by inserting the signature image in the signable region of the approval document.

The approver may draw the direct signature on the approver's mobile device to create the signature image and the approver's mobile device may convert the signature image to a binary file to transmit the binary file to the web/application server.

Creating the letter approval item may include inputting an approval line, a receiver and contents for the letter approval item; attaching files of the letter approval item; and displaying a letter summary by extracting the letter summary from a letter file of the letter approval item.

The letter summary may not include a signature and may include an unsigned page number and a signed page number.

Performing the approval of the letter approval item in the approver's mobile device may include requesting the letter approval item from the approver's mobile device to the web/application server and receiving the mobile-based approval item from the web/application server; notifying existence of the letter approval item by displaying an electronic approval widget on the approver's mobile device; displaying detailed approval information of the letter approval item on the approver's mobile device in response to a selection of the letter approval item; requesting a letter preview from the approver's mobile device to the web/application server in response to a request of the approver; requesting the letter preview from the web/application server to the database server; providing binary data of a letter file and a sample signature from the database server to the web/application server; constructing a letter preview image based on the binary data of the letter file and the sample signature in the web/application server and providing the letter preview image to the approver's mobile device; displaying the letter preview image on the approver's mobile device; and temporarily storing comments when the comments are input through the approver's mobile device.

Performing the approval of the letter approval item in the approver's mobile device further may further include displaying a signature input window in response to a touch of an approve button; when the direct signature is drawn on the signature input window by the approver, generating a signature image in response to the drawn direct signature using a graphic device interface and temporarily storing the signature image; converting the signature image to a file in response to a touch of a completion button; and transmitting the comments and the file of the signature image from the approver's mobile device to the web/application server.

The signature image may be converted to a binary file and the binary file is stored in the approver's mobile device.

According to example embodiments, a system of performing electronic approval processes, includes an approval requester's personal computer (PC), a database server, a web/application server and an approver's mobile device. The approval requester's PC creates a letter approval item including an approval document and requests an approval of the letter approval item, where the approval document includes a signable region. The database server stores the letter approval item transmitted from the approval requester's PC. The web/application server receives a mobile-based approval item including the letter approval item from the database server. The approver's mobile device receives the mobile-based approval item from the web/application server, performs the approval of the letter approval item in the approver's mobile device in response to a direct signature of an approver, and transmits comments and a signature image to the web/application server, the signature image being created in the approver's mobile device by the direct signature of the approver.

The web/application server may transmit the mobile-based approval item to the approver's mobile device when the approver's mobile device asks existence of any approval item to the web/application server. The web/application server may generate a final approval document by inserting the signature image in the signable region of the approval document.

The approver may draw the direct signature on the approver's mobile device to create the signature image and the approver's mobile device converts the signature image to a binary file to transmit the binary file to the web/application server.

The system may further include an approver's PC configured to receive a PC-based approval item including the letter approval item from the database server, configured to perform the approval of the letter approval item in the approver's PC in response to the direct signature of the approver, and configured to transmit comments and a signature image to the database server, where the signature image is created in the approver's computer by the direct signature of the approver.

The approver's mobile device may include Galaxy Note 3, Galaxy Note 8 or Galaxy Note 10.1.

According to example embodiments, a computer-readable storage medium storing an electronic approval program. The electronic approval program includes processes of creating a letter approval item including an approval document in an approval requester's personal computer (PC), the approval document including a signable region; requesting an approval of the letter approval item by transmitting the letter approval item from the approval requester's PC to a database server; notifying existence of the letter approval item by providing a mobile-based approval item including the letter approval item from the database server to a web/application server; transmitting the mobile-based approval item from the web/application server to a approver's mobile device when the approver's mobile device asks existence of any approval item to the web/application server; performing the approval of the letter approval item in the approver's mobile device in response to a direct signature of an approver; transmitting a signature image from the approver's mobile device to the web/application server, the signature image being created in the approver's mobile device by the direct signature of the approver; and generating a final approval document in the web/application server by inserting the signature image in the signable region of the approval document.

According to the method and system of performing the electronic approval processes and the computer-readable storage medium storing the electronic approval program, the approver signs the signature in person on the approver's mobile device, the signature image corresponding to the direct signature is provided as the approval completion information and thus authenticity of signature may be secured.

### BRIEF DESCRIPTION OF THE DRAWINGS

Example embodiments of the inventive concept will be more clearly understood from the following detailed description taken in conjunction with the accompanying drawings.

FIG. 1 is a diagram illustrating an electronic approval system according to example embodiments.

FIG. 2 is a diagram for describing an electronic approval method according to example embodiments.

FIG. 3 is a flowchart illustrating an electronic approval method according to example embodiments.

FIG. 4 is a diagram illustrating a letter approval creation window that is displayed on an approval requester's personal computer (PC) when a letter approval function is selected.

FIG. 5 is a diagram illustrating a search window that is displayed when a search button is clicked.

FIG. 6 is a diagram illustrating a detailed image of the letter approval creation window for describing information input through the letter approval creation window.

FIG. 7A is a diagram illustrating an image corresponding to an abnormal letter state that is displayed when a letter preview button is clicked.

FIG. 7B is a diagram illustrating an image corresponding to a normal letter state that is displayed when a letter preview button is clicked.

FIG. 8 is a diagram for describing replacement of a sample signature with a signature image.

FIG. 9 is a diagram illustrating processes of performing an approval of a letter approval item in an approver's PC.

FIG. 10 is a diagram illustrating a pop-up window that is displayed on an approver's PC.

FIG. 11 is a diagram illustrating a notification window that is displayed when a window view button is clicked.

FIG. 12 is a diagram illustrating a letter approval item window that is displayed on an approver's PC when a corresponding letter approval item is selected.

FIG. 13 is a diagram illustrating an image of a letter that is displayed when a letter view button is clicked.

FIG. 14 is a diagram illustrating a pop-up window that is displayed when a grant button is clicked.

FIG. 15 is a diagram illustrating a pop-up window that is displayed when an approval of a letter approval item is completed.

FIG. 16 is a diagram illustrating a notification window that is displayed when a confirm button is clicked.

FIG. 17 is a diagram illustrating a completed approval list window that is displayed when a completed approval function is selected.

FIG. 18 is a diagram illustrating a completed approval item window that is displayed when a corresponding completed approval item in the list of FIG. 17 is selected.

FIG. 19 is a diagram illustrating an image of a letter that is displayed when a letter preview button is clicked.

FIG. 20A and FIG. 20B are diagrams illustrating an approval document output window that is displayed when an output button in the window of FIG. 18 is clicked.

FIGS. 21A and 21B are diagrams illustrating processes of performing an approval of a letter approval item in an approver's mobile device.

FIG. 22 is a diagram illustrating an electronic approval widget.

FIG. 23 is a diagram illustrating an image that is displayed when an electronic approval button on the widget of FIG. 22 is touched.

FIGS. 24A and 24B are diagrams illustrating detailed information that is displayed when a corresponding approval item is selected.

FIG. 25 is a diagram illustrating an image of an unsigned letter.

FIG. 26 is a diagram illustrating a signature input window that is displayed on an approver's mobile device for receiving a direct signature of an approver.

FIG. 27 is a diagram illustrating an example of a direct signature drawn by an approver.

FIG. 28 is diagram illustrating a completed electronic approval items displayed on an approver's mobile device.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

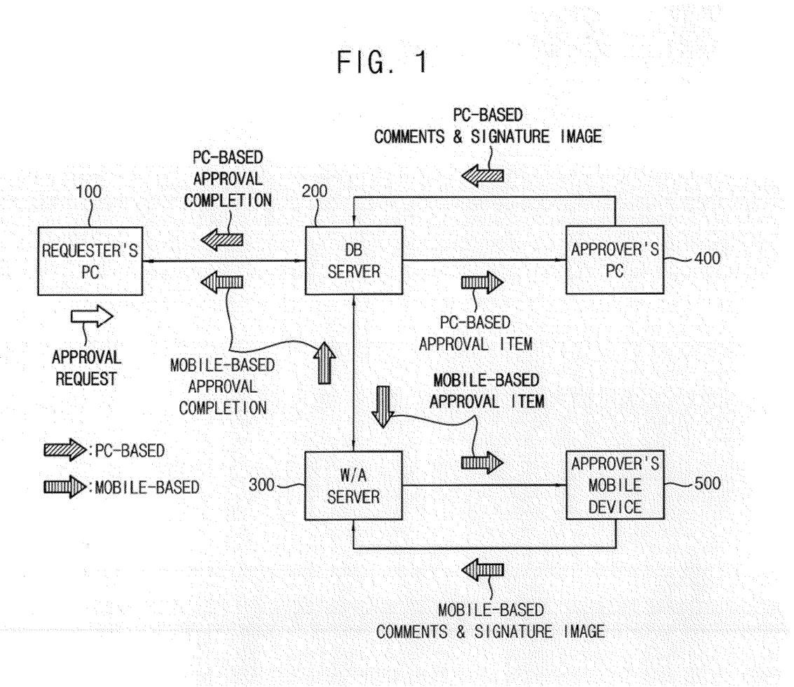

FIG. 1 is a diagram illustrating an electronic approval system according to example embodiments.

Referring to FIG. 1, an electronic approval system may include an approval requester's personal computer (PC) 100, a database (DB) server 200, a web/application (W/A) server 300, an approver's PC 400 and an approver's mobile device. In this disclosure, an electronic approval item created in the approval requester's PC 100 may include a letter approval item. Even though example embodiments are described based on the letter approval item in this disclosure, methods and systems of performing electronic approval processes according to example embodiments may be applied to general draft documents requiring signatures of multiple approvers.

Referring to FIG. 1, the electronic approval processes initiated by the approval requester's PC 100 may include a PC-based electronic approval processes through the DB server 200 and the approver's PC and a mobile-based electronic approval processes through the DB server 200, the W/A server 300 and the approver's mobile device 500. The approver may perform the approval of the electronic approval item using the approver's PC 400 and/or the approver's mobile device 500. The approver may select the approval through one of the approver's PC 400 and the approver's mobile device 500, or both of the approver's PC 400 and the approver's mobile device 500. The electronic approval program according to example embodiments is not a stand-alone type that is established and driven in one device, for example, one of the approval requester's PC 100, the DB server 200, the W/A server 300, the approver's PC 400 and the approver's mobile device 500. The electronic approval program according to example embodiments may be a plug-in type that is established and driven in the approval requester's PC 100, the DB server 200, the W/A server 300, the approver's PC 400 and the approver's mobile device 500. In other words, the electronic approval program may be configured to be operated by a plurality of devices in combination. The electronic approval program according to example embodiments may be stored in and used by a plurality of storage media.

The approval requester's PC 100 may create the letter approval item including an approval document and request an approval of the letter approval item, where the approval document includes a signable region. When creating the letter approval item, the approval requester's PC 100 may receive an approval line, an approval line, a receiver and contents for the letter approval item. The approval requester's PC 100 may attach files of the letter approval item and display a letter summary by extracting the letter summary from a letter file that is attached to the letter approval item. In addition, the approval requester's PC 100 may temporarily store contents of the letter approval item under creation when a store button is clicked. The approval requester's PC 100 may transmit the letter approval item to the DB server 200 when a approval request button. The letter summary may not include a signature and may include an unsigned page number and a signed page number. The approval requester's PC 100 may display a letter preview image when a letter preview button is clicked.

The DB server 200 may store the letter approval item transmitted from the approval requester's PC 100. The DB server 200 may notify existence of the letter approval item by transmitting a PC-based approval item to the approver's PC 400. In addition, the DB server 200 may provide a mobile-based approval item including the letter approval item to the W/A server 300.

The W/A server 300 may transmit the mobile-based approval item, which is received from the DB server 200, to the approver's mobile device 500. When comments and a signature image are transmitted from the approver's mobile device 500, the W/A server 300 may transmit mobile-based approval completion information including the signature image to the approval requester's PC 100 through the DB server 200 to notify the approval completion. In addition, when comments and a signature image are transmitted from the approver's PC 400, the DB server 200 may transmit PC-based approval completion information including the signature image to the approval requester's PC 100 to notify the approval completion.

The approver's PC 400 may receive the PC-based approval item including the letter approval item from the DB server 200, perform the approval of the letter approval item in response to the direct signature of the approver, and transmit comments and a signature image to the DB server 200. The signature image is created in the approver's computer by the direct signature of the approver.

When the comments and the signature image are transmitted from the approver's PC 400, the DB server 200 may transmit the PC-based approval completion information including the comments and the signature image to the approval requester's PC 100 to notify the approval completion.

When the approval of the letter approval item is performed in the approver's PC 400, the approver's PC 400 may display a notification window when the PC-based approval item is transmitted from the DB server 200. When a particular letter approval item is clicked, the approver's PC 400 may display details of the letter approval item. When a letter preview button is clicked, the approver's PC 400 may request the letter preview to the DB server 200. The DB server 200 may select the stored letter file corresponding to the letter approval item and provide binary data of the letter file and a sample signature to the approver's PC 400. The approver's PC 400 may load a word processor to convert the binary data to a word processor file and insert the sample signature in the signable region that will be replaced with the direct signature by the approver. The approver's PC 400 may display an image of a letter when a letter view button is clicked.

The approver's PC 400 may temporarily store comments when the comments are input by the approver. When a return button is clicked, the approver's PC may transmit the comments of the return to the DB server 200.

The approver's mobile device 500 may receive a mobile-based approval item including the letter approval item from the W/B server 300, perform the approval of the letter approval item in the approver's mobile device 500 in response to a direct signature of the approver, and transmit comments and a signature image to the web/application server, where the signature image is created in the approver's mobile device by the direct signature of the approver. The approver may draw the direct signature in person on the approver's mobile device to create the signature image and the approver's mobile device 500 may convert the signature image to a binary file to transmit the binary file to the W/A server 300.

The approver's mobile device may be an arbitrary device such as a smart phone, a tablet PC, etc., which is based on an arbitrary operating system (OS). For example, the approver's mobile device may include Galaxy Note™ 3, Galaxy Note 8 or Galaxy Note 10.1.

When an approval is performed through the direct signature of the approver in the approver's mobile device, the approver's PC 500 may request the letter approval item to the W/A server 300 and receive the mobile-based approval item from the W/A server 300. The approver's mobile device 500 may notify existence of the letter approval item by displaying an electronic approval widget on the approver's mobile device 500. The approver's mobile device 500 may displaying detailed approval information of the letter approval item on the approver's mobile device 500 in response to a selection of the letter approval item. The approver's mobile device 500 may request a letter preview to the W/A server 300 in response to a request of the approver.

The W/A server 300, which received the request of the letter preview, may request the letter preview to the DB server 200. The DB server 200 may select the stored letter file of the letter approval item and provide binary data of the letter file and a sample signature to the W/A server 300. The W/A server 300 may construct a letter preview image based on the binary data of the letter file and the sample signature and providing the letter preview image to the approver's mobile device 500. The approver's mobile device 500 may display the letter preview image on the approver's mobile device 500. The approver's mobile device 500 may temporarily store comments when the comments are input through the approver's mobile device 500.

The approver's mobile device 500 may display a signature input window in response to a touch of an approve button. When the direct signature is drawn on the signature input window by the approver, the approver's mobile device 500 may generate a signature image in response to the drawn direct signature using a graphic device interface (GDI) and temporarily store the signature image. The approver's mobile device 500 may convert the signature image to a file in response to a touch of a completion button. The signature image may be converted to a binary file and the binary file may be stored in the approver's mobile device 500.

The approver's mobile device 500 may transmit approval information and the file of the signature image to the W/A server 300. The approval information may include the comments that are input by the approver and an approval log. The approval log may include an identifier, a serial number and an internet protocol (IP) address of the approver's mobile device 500. The approver's mobile device 500 may delete the signature image file after transmitting the approval information and the signature image file to the W/A server 300.

When the approver wants to perform the approval of the letter approval item using the approver's mobile device 500, the approver may touch the letter approval item in the approval item list displayed on the approver's mobile device 500 and detailed approval information may be displayed. After confirming the detailed approval information, the approver may touch the approve button to load and display the signature input window on the approver's mobile device 500. The size of the signature input window may be set depending on the size of the touch screen of the approver's mobile device. The size of the signature input window may be increased according to the size of the touch screen.

The approver may draw the direct signature on the signature input window and the GDI may generate the signature image in response to the drawn direct signature. When the approver touches the completion button, the signature image file is stored and the signature image file and the approval information are transmitted to the W/A server 300. The approver's mobile device 500 may delete the signature image file after transmitting the approval information and the signature image file to the W/A server 300.

The W/A server 300 may store the approval information and the signature image file and then process the approval. For example, the W/A may generate a final approval document by inserting the signature image in the signable region of the approval document. The final approval document may be converted to a signed image file such as a portable document format (PDF) file and the image file may be sent through an e-mail or may be printed out. The signed image file may not be stored in the W/A server 300 and the signed image file may be directly uploaded to and stored in the DB server 200. Through such processes, the electronic approval method may be performed and completed using the approver's mobile device 500.

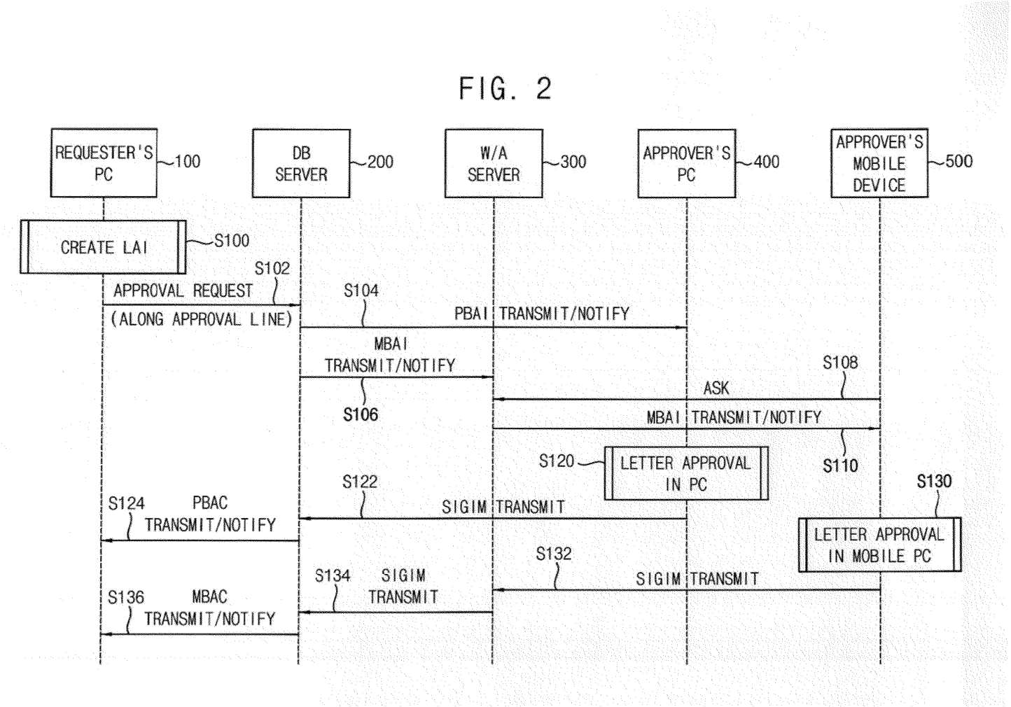

FIG. 2 is a diagram for describing an electronic approval method according to example embodiments.

Referring to FIGS. 1 and 2, the approval requester may create a letter approval item (LAI) using the approval requester's PC 100 (S100). Even though example embodiments are described based on the letter approval item in this disclosure, methods and systems of performing electronic approval processes according to example embodiments may be applied to general draft documents requiring signatures of multiple approvers. In this disclosure, letters associated with intellectual property application of patent, trade mark, design, etc. may be used to describe example embodiments.

The electronic approval program established in the approval requester's PC 100 may request the approval of the created letter approval item to the DB server 200 along the approval line (S102). The DB server 200 may notify existence of the letter approval item by providing the PC-based approval item (PBAI) including the letter approval item to the approver's PC 400 (S104). In addition, the DB server 200 may notify existence of the letter approval item by providing the mobile-based approval item (MBAI) including the letter approval item to the W/A server 300 (S106).

The electronic approval program established in the approver's mobile device 500 may ask existence of any approval item to the W/A server 300 (S108). When the approval item to be approved exists, the W/A server 300 may transmit and notify the mobile-based approval item to the approver's mobile device 500 (S110).

The electronic approval program established in the approver's PC 400 may perform the approval of the letter approval item in the approver's PC 400 in response to the direct signature of the approver (S120). The letter approval in the approver's PC 400 (S120) will be further described below.

After the letter approval is performed, the electronic approval program established in the approver's PC 400 may transmit the signature image (SIGIM) to the DB server 200 (S122). When the signature image is transmitted from the approver's PC 400, the DB server 200 may transmit the PC-based approval completion information (PBAC) to the approval requester's PC 100 and notify the approval of the letter approval item is completed (S124).

When the mobile-based approval item is transmitted (S110), the electronic approval program established in the approver's mobile device 500 may perform the approval of the letter approval item in the approver's mobile device 500 in response to the direct signature of the approver (S130). The letter approval in the approver's mobile device (S130) will be further described below.

After the letter approval is performed, the electronic approval program established in the approver's mobile device 500 may transmit the signature image (SIGIM) to the W/A server 300 (S132). When the signature image is transmitted from the approver's mobile device 500, the W/A server 300 may transmit the signature image to the DB server 200 (S134) and the DB server may transmit the mobile-based approval completion information (MBAC) to the approval requester's PC 100 and notify the approval of the letter approval item is completed (S136).

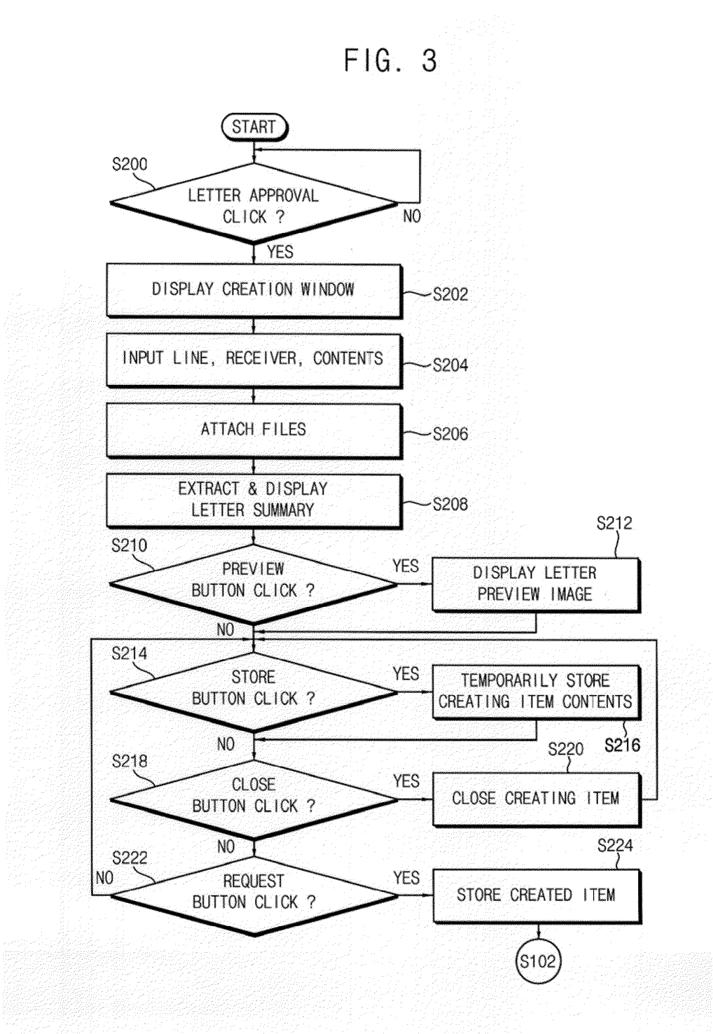

FIG. 3 is a flowchart illustrating an electronic approval method according to example embodiments.

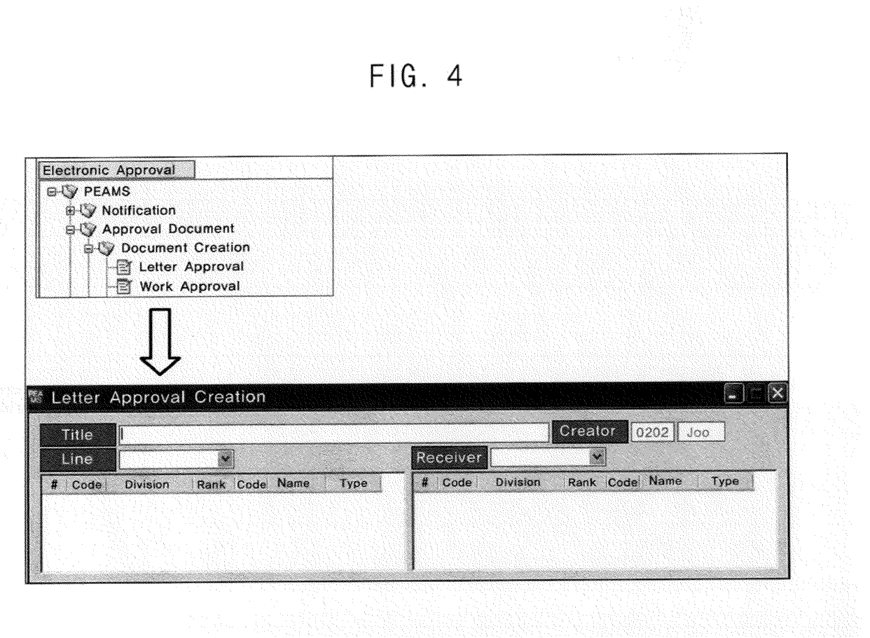

Referring to FIGS. 1, 2 and 3, the electronic approval program established in the approval requester's PC 100 may check whether the letter approval function is selected (S200). For example, the letter approval function may be selected by clicking the corresponding tab as illustrated in FIG. 4. In this disclosure, letters associated with intellectual property application of patent, trade mark, design, etc. may be used to describe example embodiments.

When the letter approval is clicked (S200: YES), the electronic approval program established in the approval requester's PC 100 may display a letter approval creation window (S202).

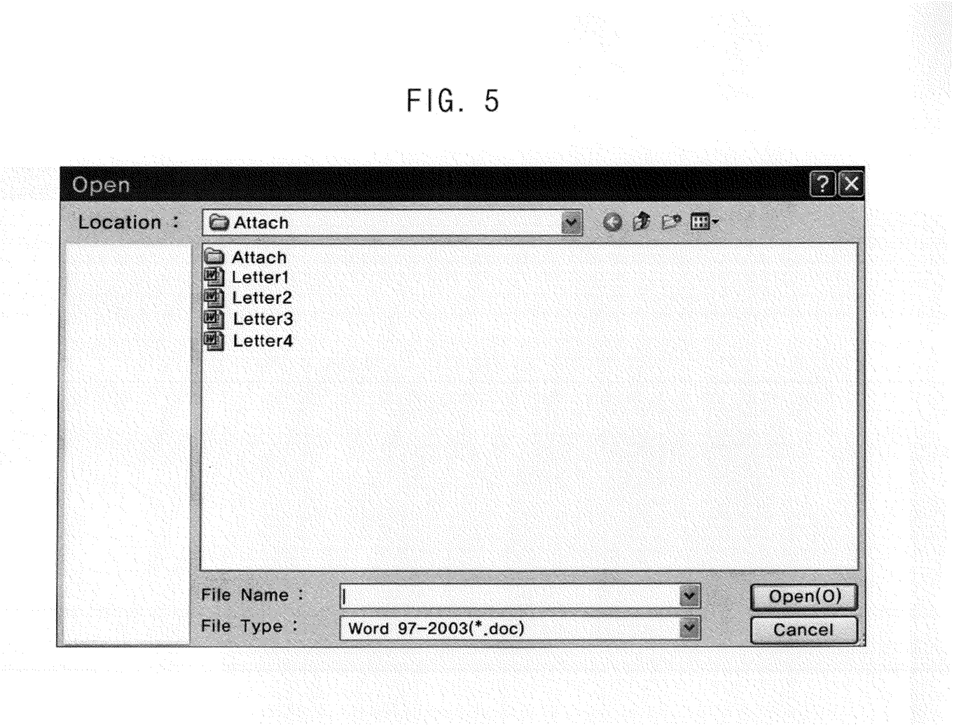

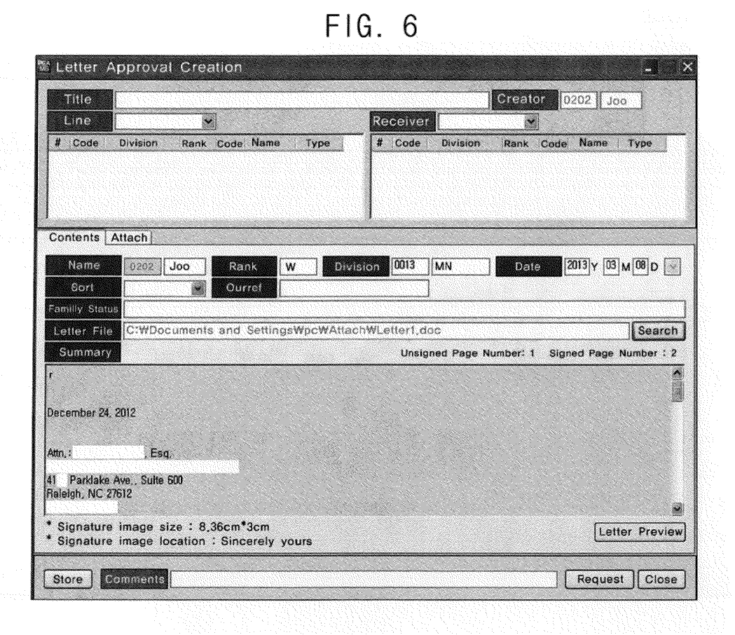

FIG. 4 is a diagram illustrating a letter approval creation window that is displayed on an approval requester's personal computer (PC) when a letter approval function is selected, FIG. 5 is a diagram illustrating a search window that is displayed when a search button is clicked, and FIG. 6 is a diagram illustrating a detailed image of the letter approval creation window for describing information input through the letter approval creation window.

Referring to FIGS. 4 and 6, when the letter approval is clicked, the electronic approval program established in the approval requester's PC displays the letter approval creation window. The letter approval creation window may include fields for inputting a title, a creator, an approval line, contents, a field for selecting attached files, a field for displaying a letter summary, a field for inputting comments, etc.

Referring back to FIG. 3, the electronic approval program established in the approval requester's PC 100 may receive the approval line, the receivers, and the contents for the letter approval item (S204), which are input by the approval requester. For example, through the letter approval creation window as illustrated in FIG. 6, the approval requester may input the title, input or select the approval line and receivers. In addition, the approval requester may input or select the name, the rank and the division of the creator, the date, the sort, the reference number, etc. In case of the letter associated with the patent application to multiple nations, the family status may be further input.

The electronic approval program established in the approval requester's PC 100 may attach files to the letter approval item (S206). When the approval requester clicks the attach button and the search button in the letter approval creation window of FIG. 6, the electronic approval program established in the approval requester's PC 100 may display the search window as illustrated in FIG. 5. The approval requester may search the directory storing the file to be attached though the search window.

The electronic approval program established in the approval requester's PC 100 may display a letter summary by extracting the letter summary from a letter file that is attached to the letter approval item (S208) as illustrated in FIG. 6. For example, when the letter file is generated by the Microsoft (MS) word, the text data of the MS word file may be extracted as the letter summary. The signature is not included in the letter summary. The signature image size and location may be displayed under the letter summary field. Also the unsigned page number and the signed page number, that is, the page numbers of the letter before and after signing may be displayed. When the approval requester creates the letter file, the page number of the letter may be optimized by adjusting the space between the lines, the font size, etc.

The electronic approval program established in the approval requester's PC 100 may check whether the letter preview button in the window of FIG. 6 is clicked (S210). When the letter preview button is clicked (S210: YES), the electronic approval program may display the letter preview image (S212). The letter preview image may be abnormal or normal depending on the adjustments of the letter file by the approval requester.

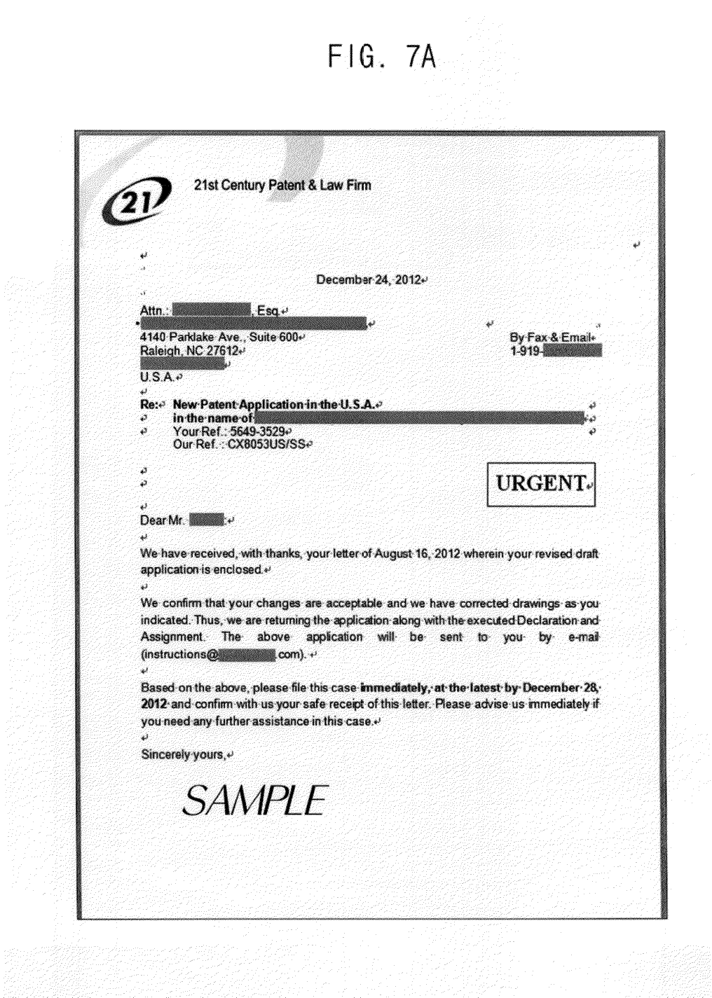

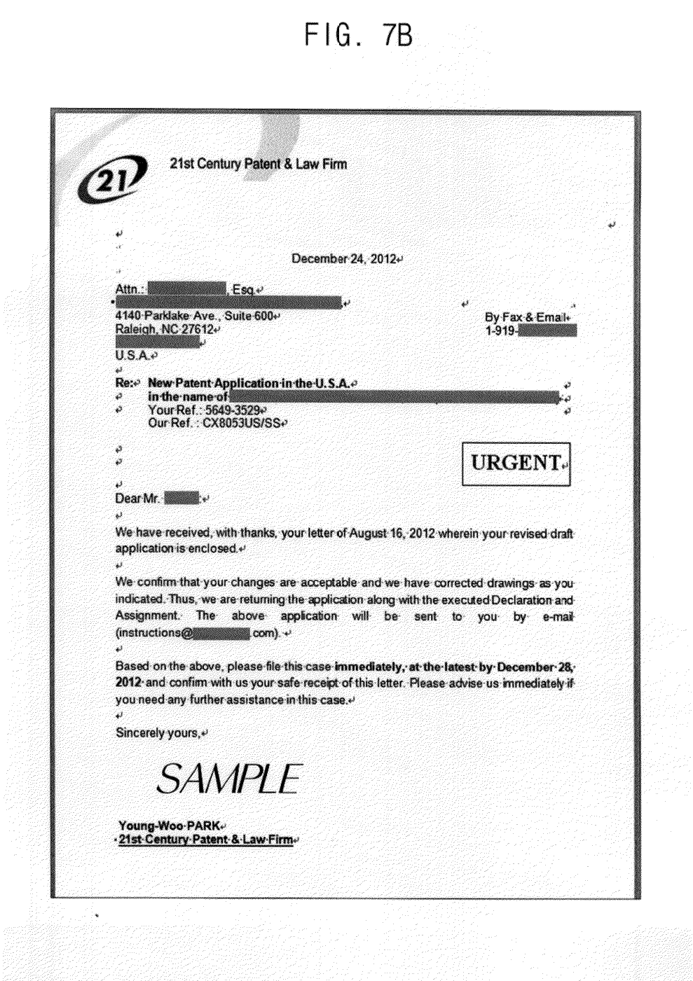

FIG. 7A is a diagram illustrating an image corresponding to an abnormal letter state that is displayed when a letter preview button is clicked, and FIG. 7B is a diagram illustrating an image corresponding to a normal letter state that is displayed when a letter preview button is clicked.

Referring to FIG. 7A, the name of the approver, the name of the firm, etc. may be located not under the sample signature but in the next page. In other words, when printing the letter, only the name of the approver, the name of the firm, etc. may be printed improperly as a distinct page. By adjusting the space between the lines, the font size, etc. with considering the size and/or location of the signature, the page number of the letter may be properly adjusted as illustrated in FIG. 7B. The sample signature image is inserted in the letter preview images of FIGS. 7A and 7B to adjust the space between the lines, the font size, etc. The sample signature image is replaced with the signature image of the approver after the direct signature is performed by the approver.

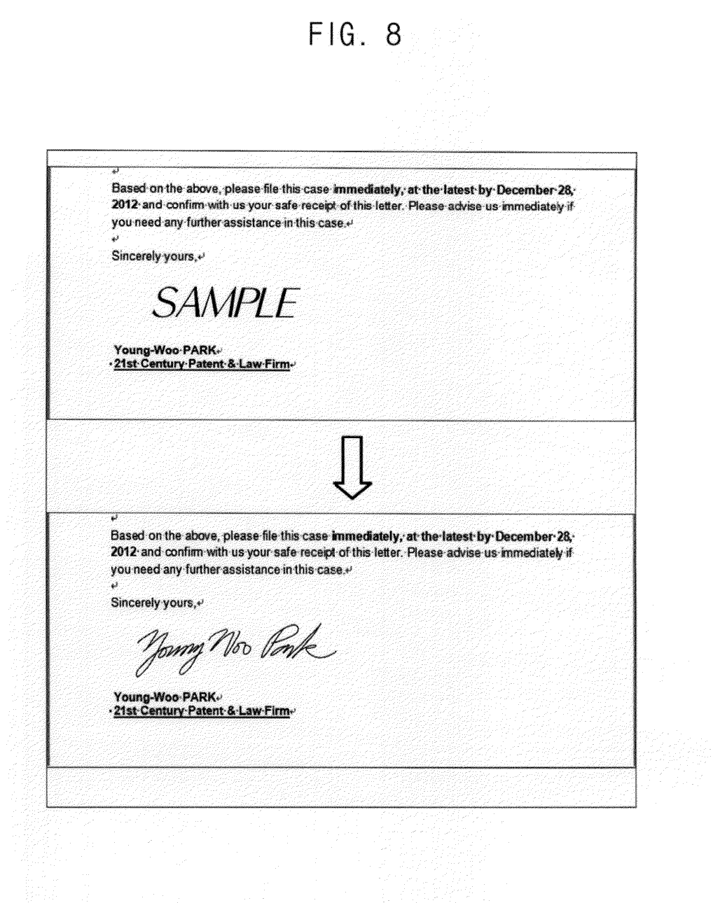

FIG. 8 is a diagram for describing replacement of a sample signature with a signature image.

FIG. 8 illustrates a portion of the letter preview image including the sample signature and a corresponding portion of the final letter image including the direct signature of the approver. In the letter word file created by the approval requester, one line under “Sincerely yours” may be blanked to which the sample signature is inserted. When the letter preview button is touched, the letter preview image is constructed by inserting the sample signature in the blanked line. After the direct signature of the approver is obtained, the direct signature is inserted in the blanked line instead of the sample signature. The blanked line in the letter word file or the region of the sample image in the letter preview image may be referred to as the signable region.

When the letter preview button is not clicked (S210: NO) or after the letter preview image is displayed (S212), the electronic approval program established in the approval requester's PC 100 may check whether the store button is clicked (S214). When the store button is clicked (S214: YES), the electronic approval program established in the approval requester's PC 100 may temporarily store the contents of the creating letter approval item (S216).

When the store button is not clicked (S214: NO) or after the contents are stored (S216), the electronic approval program established in the approval requester's PC 100 may checked whether the close button is clicked (S218). When the close button is clicked (S218: YES), the creating letter approval item may be closed (S220) and the process returns to the step 214. When the close button is clicked, the creation of the letter approval item may be canceled.

When the close button is not clicked (S218: NO), the electronic approval program established in the approval requester's PC 100 may check whether the request button is clicked (S222). When the request button is not clicked (S222: NO), the process returns to the step 214.

When the request button is clicked (S222: YES), the electronic approval program established in the approval requester's PC 100 may store the created letter approval item (S224) and transmit the approval process information to the DB server 200 to be stored therein. The document or the signature in the approval process information stored in the DB server 200 may be prevented from copying. When the document or the signature may be stored in a form of a word file, and information resource management (IRM) function may be assigned to the word file to restrict the use of the word file. For example, using the IRM function of the MS word, the right to access and use the word file and the email message may be assigned per user and the unauthorized user cannot print and copy the word file and the email message. The access right is stored in the word file or the email message itself in the IRM function, the protection of the important document and message may be secured regardless of the location of information by restricting the access right to the document and message.

The processes of creating the letter approval item by the approval requester have been described with reference to FIGS. 3 through 8. When the approver requests to modify the requested approval item, the processes of modifying the letter approval item may be performed similarly, and thus the repeated descriptions are omitted.

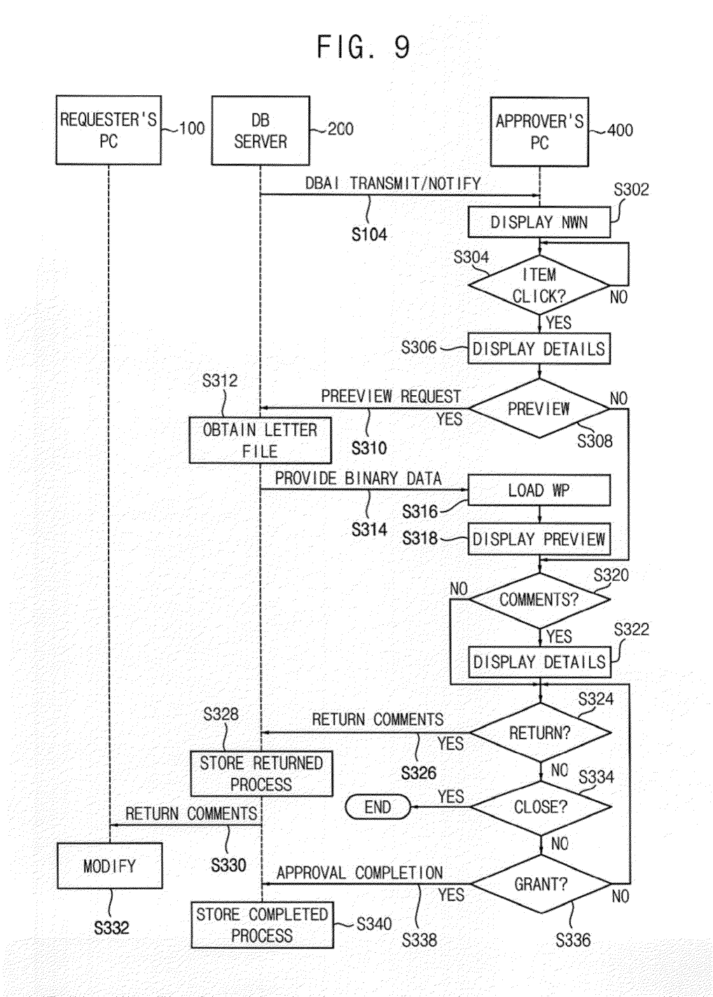

FIG. 9 is a diagram illustrating processes of performing an approval of a letter approval item in an approver's PC.

Referring to FIGS. 1, 2 and 9, when the PC-based approval item (PBAI) is transmitted from the DB server 200 (S104), the electronic approval program established in the approver's PC 400 may display the notification window (NWN) (S302). In this disclosure, letters associated with intellectual property application of patent, trade mark, design, etc. may be used to describe example embodiments.

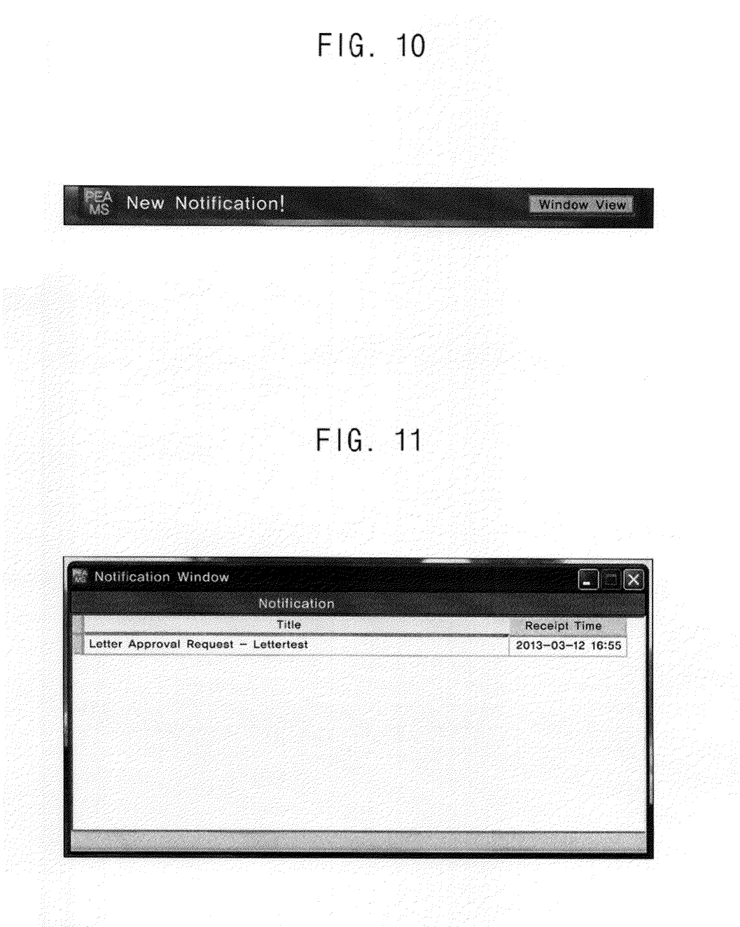

FIG. 10 is a diagram illustrating a pop-up window that is displayed on an approver's PC, and FIG. 11 is a diagram illustrating a notification window that is displayed when a window view button is clicked.

The pop-up window may include the message of “New Notification !” and the window view button. While the approver works using the approver's PC, the approver can recognize existence of the new notification when the pop-up window is displayed. By clicking the window view button, the approver can check the list of the approval items in the notification window as illustrated in FIG. 11.

Referring back to FIG. 9, the electronic approval program established in the approver's PC 400 may check whether a particular approval item is clicked or selected (S304). When the letter approval item is clicked (S304: YES), the electronic approval program established in the approver's PC 400 may display details of the letter approval item (S306).

FIG. 12 is a diagram illustrating a letter approval item window that is displayed on an approver's PC when a corresponding letter approval item is selected.

Referring to FIG. 12, the letter approval item window may include detailed information such as the name of the approver, the title of the letter to be signed, the comments, etc. The comments may be input by the creator (that is, the approval requester) and/or the approver. At least a portion of information in the window of FIG. 6 may be included in the window of FIG. 12. The multiple approvers along the approval line may be displayed in the letter approval item window. Because the receivers or the approvers are displayed on the window, any approver may check whether the approval line from the approval requester to the final approver is right or false. When the approval line is false or the contents of the letter approval item include errors, the approver may click the return button with the associated comments.

Referring back to FIG. 9, the electronic approval program established in the approver's PC 400 may check the letter view button (or the letter preview button) is clicked (S308). The approver may click the letter view button to preview and check the letter created by the approval requester. When the letter view button is clicked (S308: YES), the electronic approval program established in the approver's PC 400 may request the letter preview to the DB server 200 (S310). The DB server 200 obtains the stored letter file of the corresponding letter approval item (S312) and provides the binary data of the letter file and sample signature to approver's PC 400 (S314).

For example, the electronic approval program established in the approver's PC 400 may upload a word processor (WP) such as the MS word to convert the binary data to the word file and insert the sample signature in the signable region (S316). The electronic approval program established in the approver's PC 400 may display the letter preview (S318).

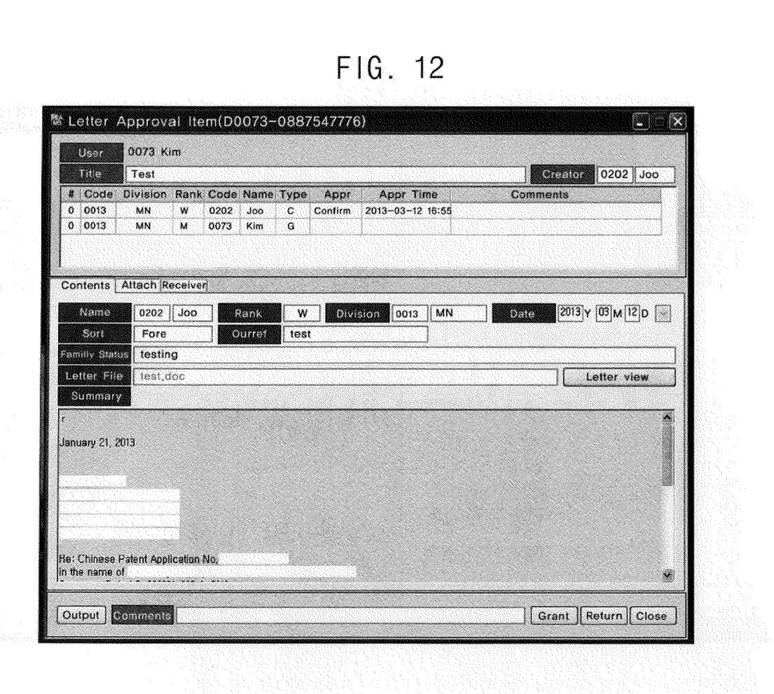

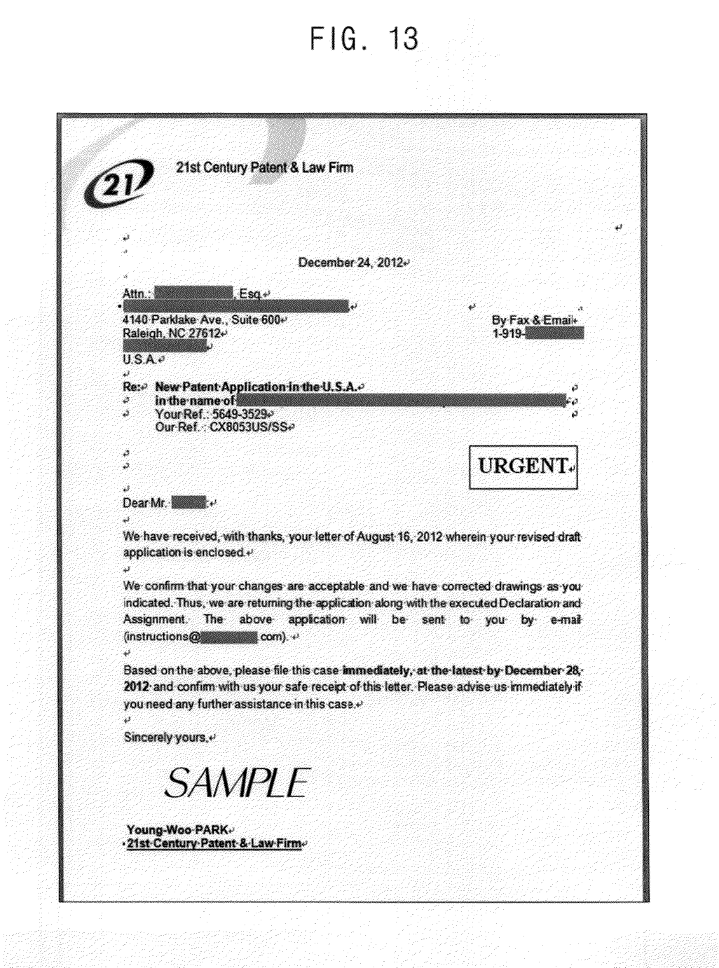

FIG. 13 is a diagram illustrating an image of a letter that is displayed when a letter view button is clicked.

Referring to FIG. 13, the binary data are converted to the word file and the sample signature is inserted to inform the location to which the direct signature of the approver is inserted. The sample signature may be provided from the DB server 200 or the sample signature may be omitted and only the binary data may be provided form the DB server 200 according to example embodiments.

Referring back to FIG. 9, When the letter view button is not clicked (S308: NO) or after the letter preview is displayed (S318), the electronic approval program established in the approver's PC 400 may check whether the comments are input through the window of FIG. 12 by the approver (S320). When the comments are input (S320: YES), the electronic approval program established in the approver's PC 400 may temporarily store the comments (S322).

When the comments are not input (S320: NO) or after the comments are stored (S322), the electronic approval program established in the approver's PC 400 may check whether the return button is clicked (S324).

When the return button is clicked (S324: YES), the electronic approval program established in the approver's PC 400 may transmit the return comments to the DB server 200 (S326). The DB server 200 may store the returned process (S328) and transmit the return comments to the approval requester's PC 100 (S330).

The approval requester may modify the returned letter approval item (S332) in response to the return comments. The approval requester may request the approval of the modified letter approval item to the DB server 200 and then the process returns to the step S104.

When the return button is not clicked (S324: NO), the electronic approval program established in the approver's PC 400 may check whether the close button is clicked (S334). When the close button is clicked (S334: YES), the electronic approval program is ended.

When the close button is not clicked (S334: NO), the electronic approval program established in the approver's PC 400 may check whether the grant button is clicked (S336). When the grant button is not clicked (S336: NO), the process returns to the step S324.

When the grant button is clicked (S336: YES), the electronic approval program established in the approver's PC 400 may provide the approval completion information to the DB server 200 (S338). In addition, another pop-up window may be displayed on the approver's PC when the grant button is clicked. For example, if the approver set, in the mobile device 500, both of the approver's PC 400 and the mobile device 500 to be used in approving the letter approval item, the pop-up window may be displayed on the approver's PC 400 to inform that the mobile device 500 is waiting the direct signature when the grant button is clicked.

FIG. 14 is a diagram illustrating a pop-up window that is displayed when a grant button is clicked.

Referring to FIG. 14, the pop-up window including the message of “Waiting Mobile Signature” is displayed when the approver clicks the grant button in the window of FIG. 12. If the approver clicks the mobile signature button in the window of FIG. 14, the approver may draw the direct signature on the registered mobile device 500.

In contrast, the approver may draw the direct signature on the region in the window of FIG. 14 using a digitizer pen, a stylus pen, etc. and click the approve button to complete the approval process. The approver may invalidate the drawn signature by clicking the erase button. The approver may cancel the approval process by clicking the cancel button.

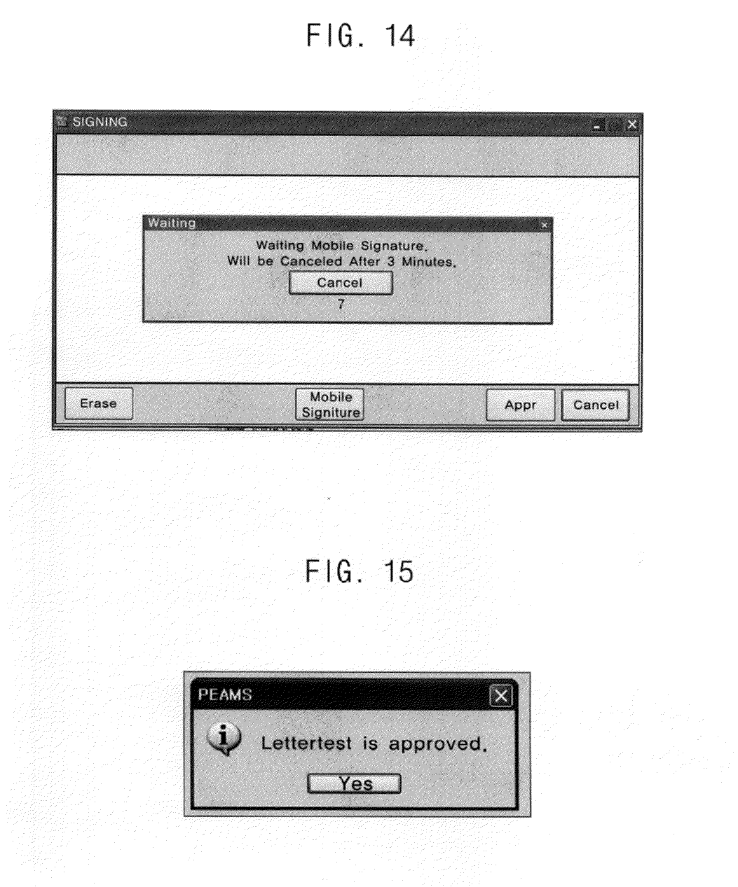

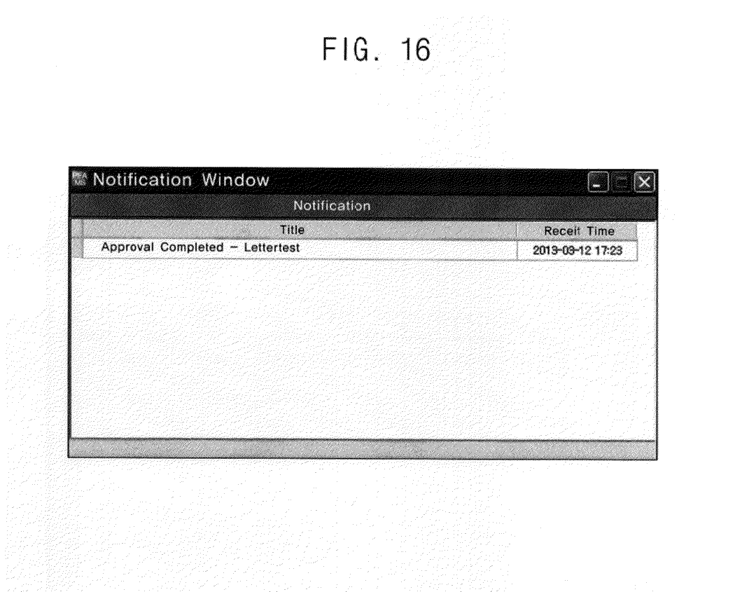

FIG. 15 is a diagram illustrating a pop-up window that is displayed when an approval of a letter approval item is completed, and FIG. 16 is a diagram illustrating a notification window that is displayed when a confirm button is clicked.

If the approver draws the direct signature through the window of FIG. 14 or the mobile device 500 and clicks the approve button, the pop-up window as illustrated in FIG. 15 may be displayed to inform that the approval of the letter approval item is completed. The approver may recognize the success of the approval and, when the approver clicks the yes button in the window of FIG. 15, the notification window as illustrated in FIG. 16 may be displayed to provide the completed approval item list.

Referring back to FIG. 9, the DB server 200 may store the completed process information (S340) that is provided from the approver's PC 400.

The processes of performing the approval of the letter approval item in the approver's PC 400 have been described with reference to FIGS. 9 through 16. The electronic approval program established in the approver's PC 400 may further provide the function of checking the list of the letter approval items completed by the approver.

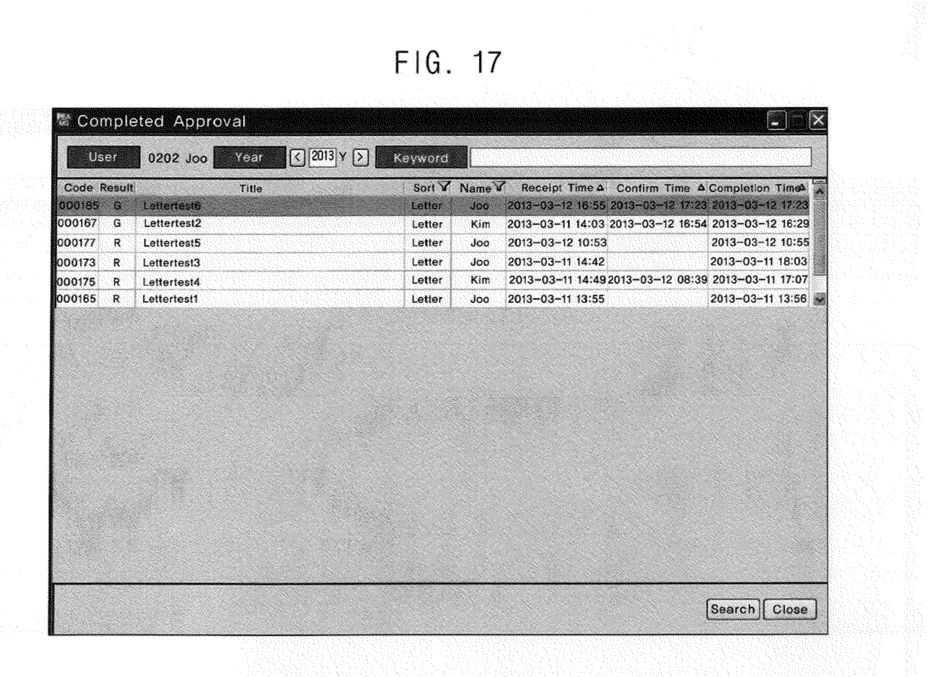

Hereinafter, the function of checking the list of the letter approval items completed by the approver is described with reference to FIGS. 17 through 20B.

FIG. 17 is a diagram illustrating a completed approval list window that is displayed when a completed approval function is selected.

Referring to FIG. 17, the completed approval list may include the completed approval items with the code, the result, the title, the sort, the creator, the receipt time, the confirm time, the completion time, etc. The result may indicate the corresponding approval item is completed or returned. Through the information displayed on such completed approval list, the approver may check and manage the approval cases.

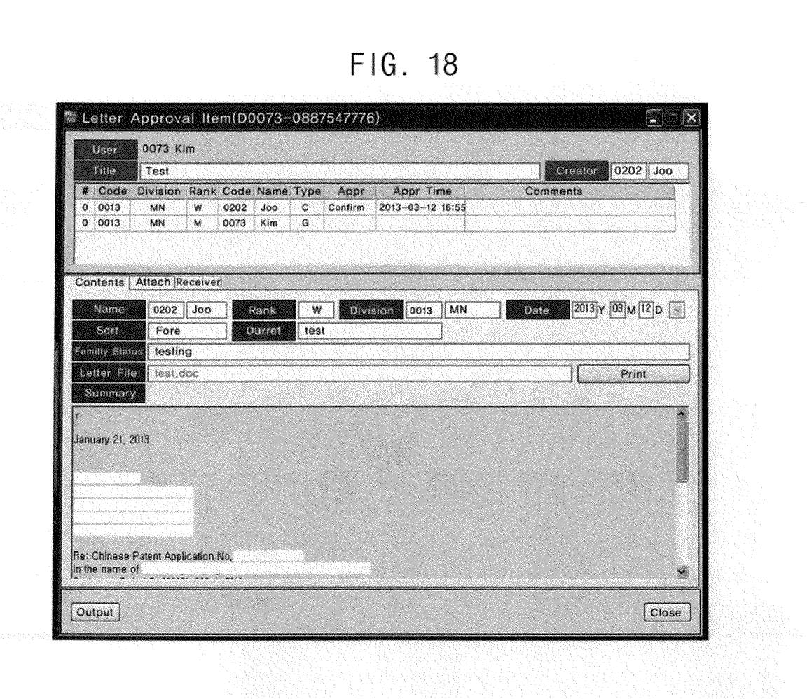

FIG. 18 is a diagram illustrating a completed approval item window that is displayed when a corresponding completed approval item in the list of FIG. 17 is selected.

Referring to FIG. 18, the letter approval item window may include detailed information such as the name of the approver, the title of the letter that has been signed, the approval time, the comments, etc. In addition, the letter approval item window may include the contents of the letter approval item, attached files, etc. Also the above-described letter summary may be displayed on the letter approval item window. The approver may check the signed letter image by clicking the letter view button.

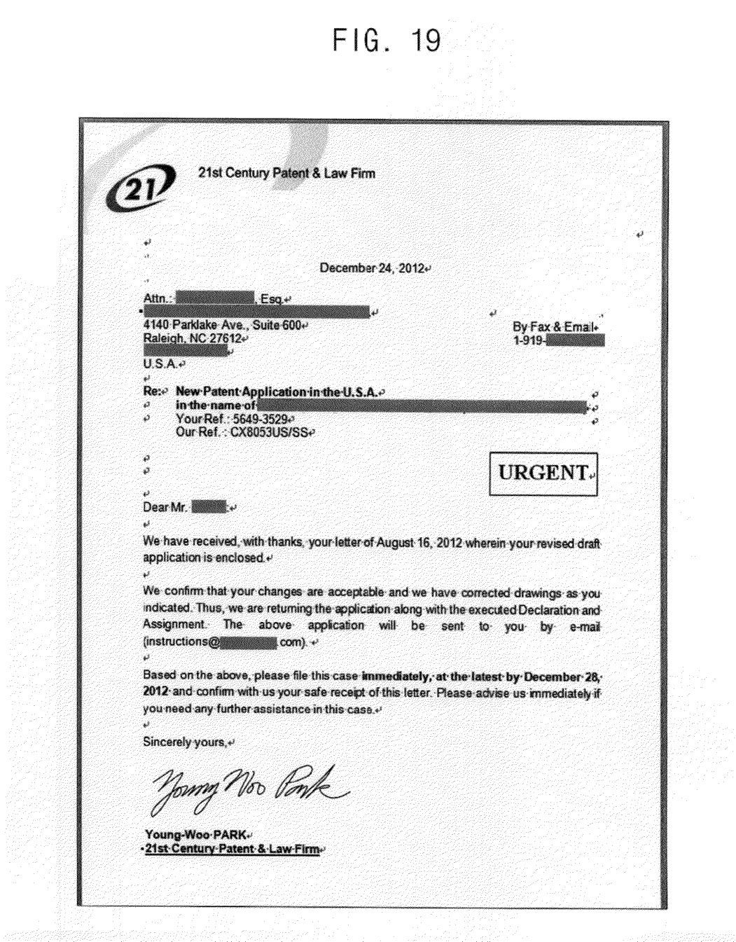

FIG. 19 is a diagram illustrating an image of a letter that is displayed when a letter preview button is clicked.

As illustrated in FIG. 19, the approver may check the signed letter in the letter preview image and check whether the direct signature is inserted properly in the letter to be printed normally.

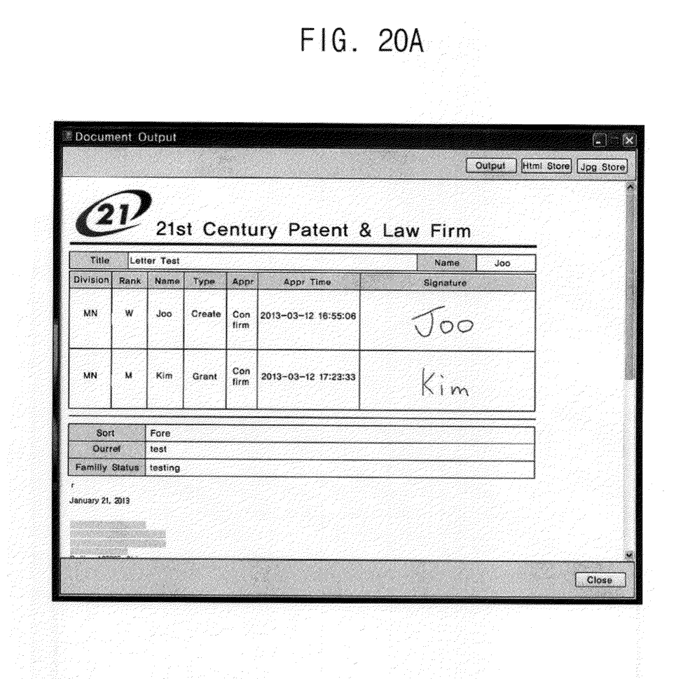

FIG. 20A and FIG. 20B are diagrams illustrating an approval document output window that is displayed when an output button in the window of FIG. 18 is clicked.

Referring to FIGS. 20A and 20B, the approval document output window may include the title of the letter, information of the creator and the approver, the type of the approval item, approval time, the direct signatures, etc.

In addition, the approval document output window may include the text of the letter. Furthermore, the approval document output window may include the comments of the approval requestor (or the creator) and the approver, the attached files, etc. The approver may check the attached file by double-clicking the attached file.

As such, the approver may check and manage the list of the completed approval items in addition to the contents of each approval item, and thus the record may be used to clarify the matter of responsibility in case of mistake or error.

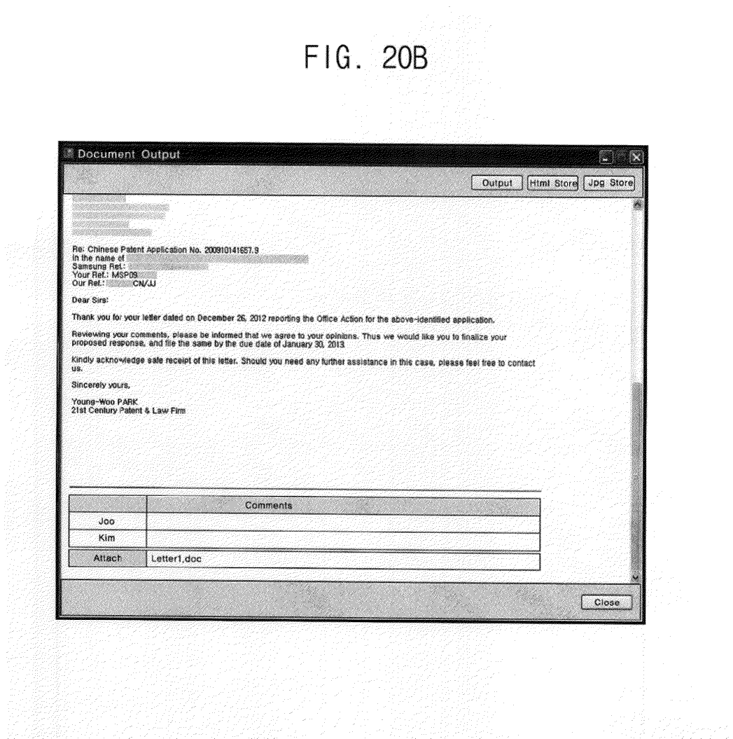

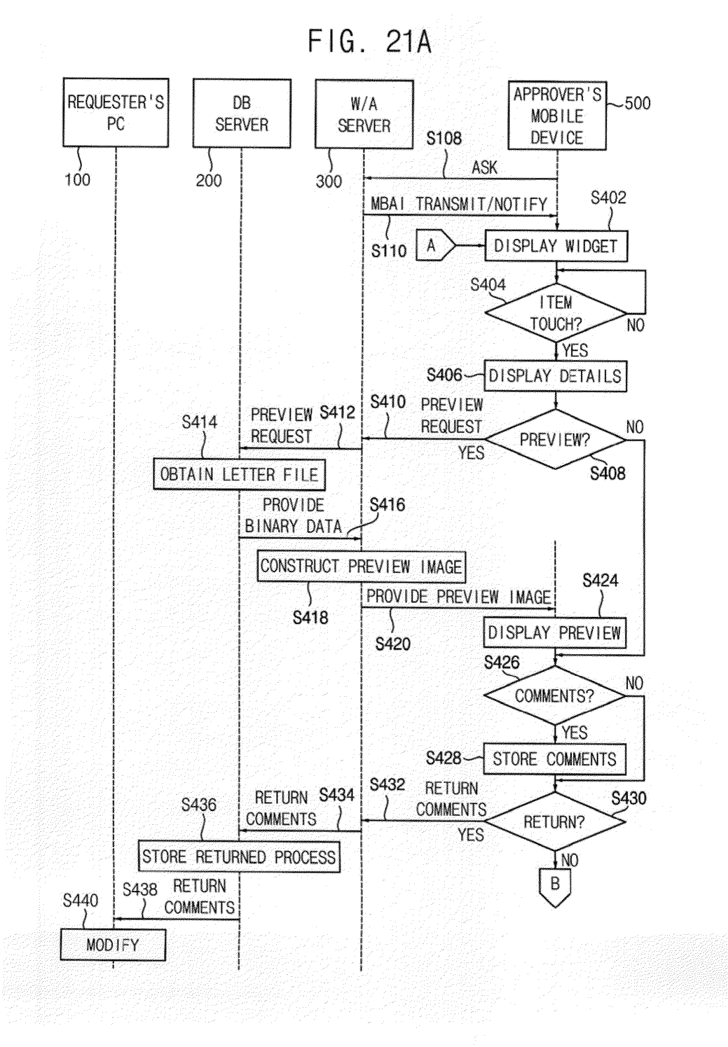

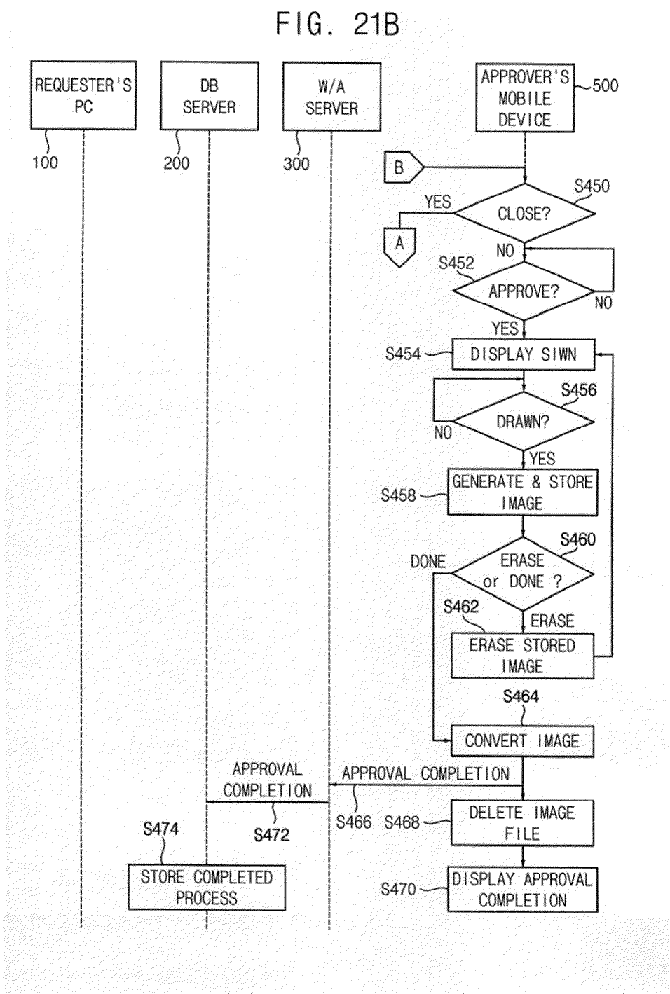

FIGS. 21A and 21B are diagrams illustrating processes of performing an approval of a letter approval item in an approver's mobile device.

Referring to FIGS. 1, 2, 21A and 21B, the electronic approval program established in the approver's mobile device 500 may ask existence of any approval item to the W/A server 300 (S108). When the approval item to be approved exists, the W/A server 300 may transmit and notify the mobile-based approval item to the approver's mobile device 500 (S110). In this disclosure, letters associated with intellectual property application of patent, trade mark, design, etc. may be used to describe example embodiments.

The electronic approval program established in the approver's mobile device 500 may display an electronic approval widget (S402) to notify the existence of the letter approval item to be approved.

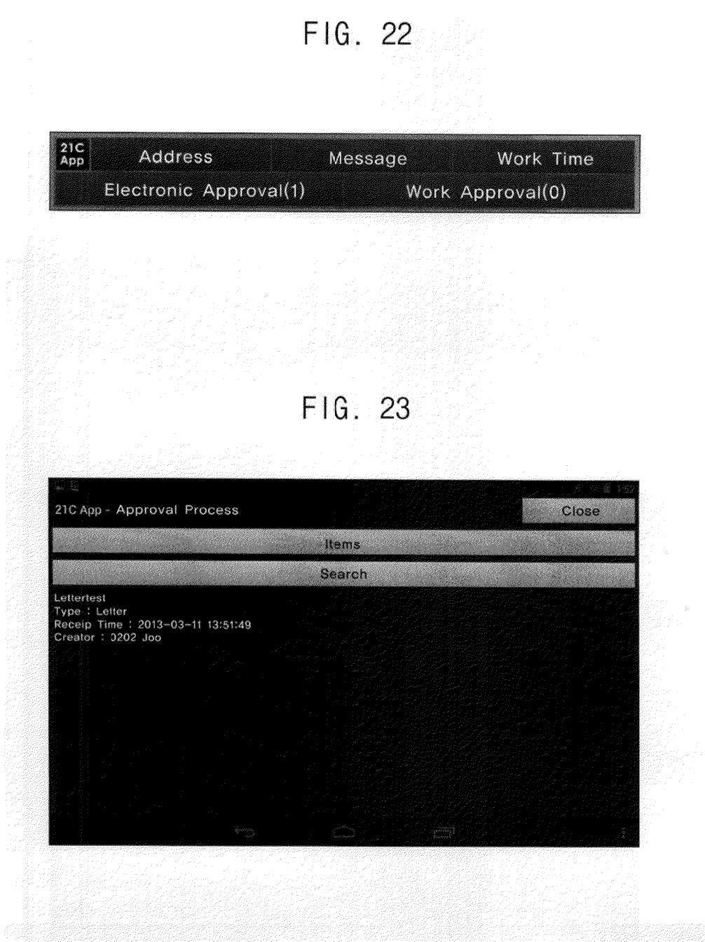

FIG. 22 is a diagram illustrating an electronic approval widget.

Referring to FIG. 22, the electronic approval widget may provide various functions such as the address, the message, the work time, the work approval, etc. in addition to the electronic approval function. The number of the approval items to be approved may be displayed on the widget. For example, the widget of FIG. 22 is indicating there is one approval item to be approved.

FIG. 23 is a diagram illustrating an image that is displayed when an electronic approval button on the widget of FIG. 22 is touched.

Referring to FIG. 23, brief information such as the title of the approval document, the type of the approval document, the receipt time of the approval document, the creator information may be displayed when the electronic approval button on the widget of FIG. 22 is touched. The approver may check the brief information and determine whether the approval item has to be approved promptly or may be approved later.

Referring back to FIGS. 21A and 21B, the electronic approval program established in the approver's mobile device 500 may check whether a particular approval item is touched or clicked (S404). For example, the particular approval item may be the letter approval item in the name of “Lettertest” in FIG. 23.

When the particular approval item is touched (S404: YES), the electronic approval program established in the approver's mobile device 500 may display details of the particular approval item (S406).

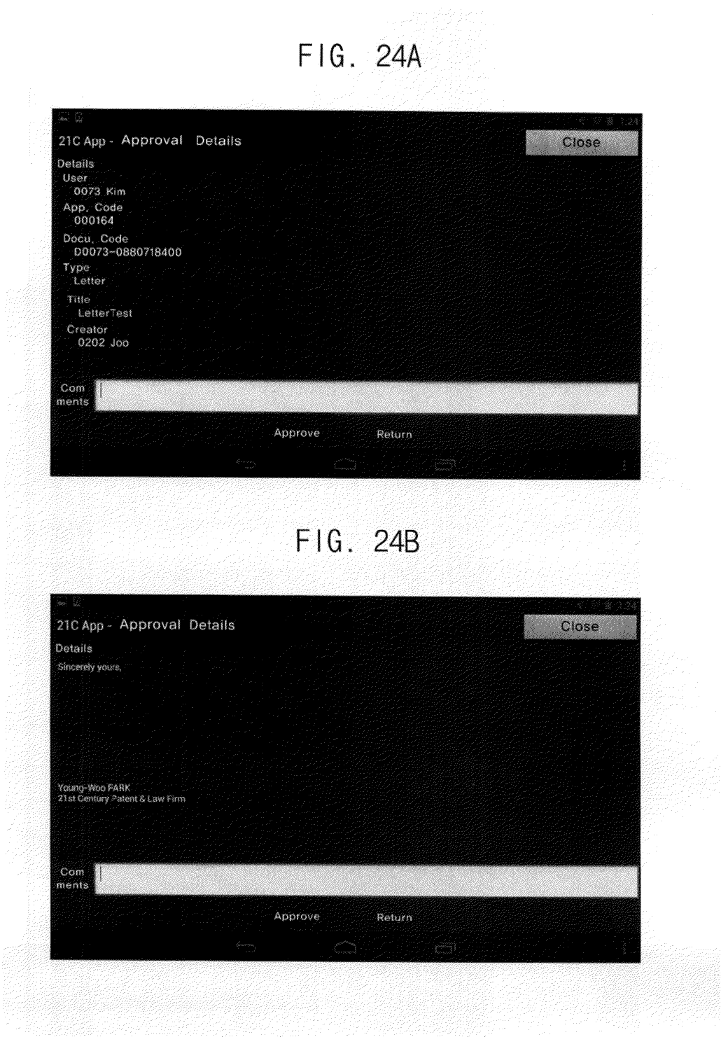

FIGS. 24A and 24B are diagrams illustrating detailed information that is displayed when a corresponding approval item is selected.

Referring to FIGS. 24A and 24B, the approval details may include the user name, the approval code, the document code, the approval type, the title of the approval document, the creator name, the approval line, etc. In case of the letter approval item, the contents corresponding to the letter may be displayed. In addition, the information may be displayed to indicate whether the letter file is attached. The approver, that is, the user of the mobile device may input the comments in the blank of the bottom portion of the display monitor or the touch screen. When the entire information is too much to be displayed in the monitor at the same time, dragging and scrolling may be applied to display the information sequentially. Through the automatic rotation function, the lines of the information may be displayed in the horizontal direction or the vertical direction.

Referring back to FIGS. 21A and 21B, the electronic approval program established in the approver's mobile device 500 may check whether the preview is requested (S408). For example, the preview may be requested by touching the attached file.

When the preview is requested (S408: YES), the electronic approval program established in the approver's mobile device 500 may request the preview of the attached file to the W/A server 300 (S410), and the W/A server 300 may request the preview to the DB server 200 (S412). For example, when the preview of the letter is requested, the DB server 200 may obtain the letter file (S414), and provide the binary data of the letter file and the sample signature to the W/A server 300 (S416). The W/A server 300 may construct a letter preview image based on the binary data of the letter file and the sample signature (S418) and provide the letter preview image to the approver's mobile device 500 (S420). The electronic approval program established in the approver's mobile device 500 may display the provided letter preview image (S424)

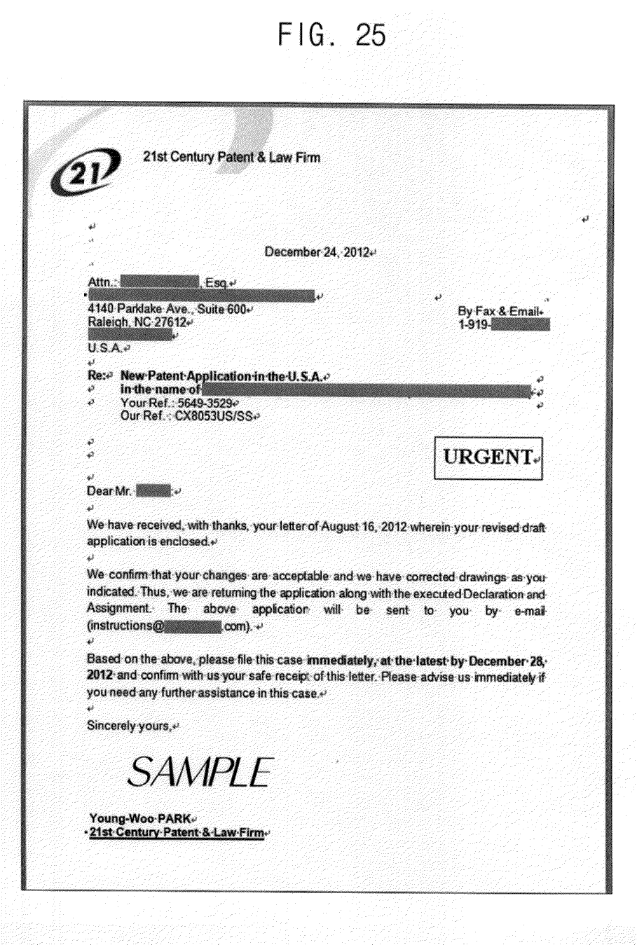

FIG. 25 is a diagram illustrating an image of an unsigned letter.

Referring to FIG. 25, the sample signature may be inserted in the letter to form the letter preview image. Through the letter preview image including the sample signature, the approver may check the signed letter in advance. For example, the approver may check whether the contents of the letter are right and/or whether the page of the letter increases unnecessarily by inserting the direct signature. The displayed letter preview image may be closed when the image is touched. When the letter preview image is closed, the monitor of the mobile device may return to the previous state as illustrated in FIG. 24B.

Referring to FIGS. 21A and 21B, when the preview is not requested (S408: NO) or after the letter preview image is displayed (S424), the electronic approval program established in the approver's mobile device 500 may check whether the comments are input (S426). As described above, the comments may be input through the blank in the bottom portion of FIGS. 24A and 24B. The mobile device 500 may be a tablet PC, and a keyboard window may be displayed in a portion of the touch screen of the tablet PC when the blank for the comments is touched. The comments may be the approval comments corresponding to the approval of the letter approval item or the return comments corresponding to the return of the letter approval item. When the comments are input, the electronic approval program established in the approver's mobile device 500 may temporarily store the comments (S428).

When the comments are not input (S426: NO) or after the comments are stored (S428), the electronic approval program established in the approver's mobile device 500 may check whether the return button is touched (S430). When the return button is touched (S430: YES), the electronic approval program established in the approver's mobile device 500 may transmit the return comments to the W/A server 300 (S432) and the W/A server 300 transmits the return comments to the DB server 200 (S434). The DB server 200 may store the returned process information (S436) and transmits the return comments to the approval requester's PC 100 (S438).

The approval requester may modify the returned letter approval item (S440) in response to the return comments. The approval requester may request the approval of the modified letter approval item to the W/A server 300 via the DB server 200 and then the process returns to the steps S108 and S110.

When the return button is not touched (S430: NO), the electronic approval program established in the approver's mobile device 500 may check the close button in FIGS. 24A and 24B is touched (S450). When the close button is touched (S450: YES), the process returns to the step 402.

When the close button is not touched (S450: NO), the electronic approval program established in the approver's mobile device 500 may check whether the approve button in FIGS. 24A and 24B is touched (S452).

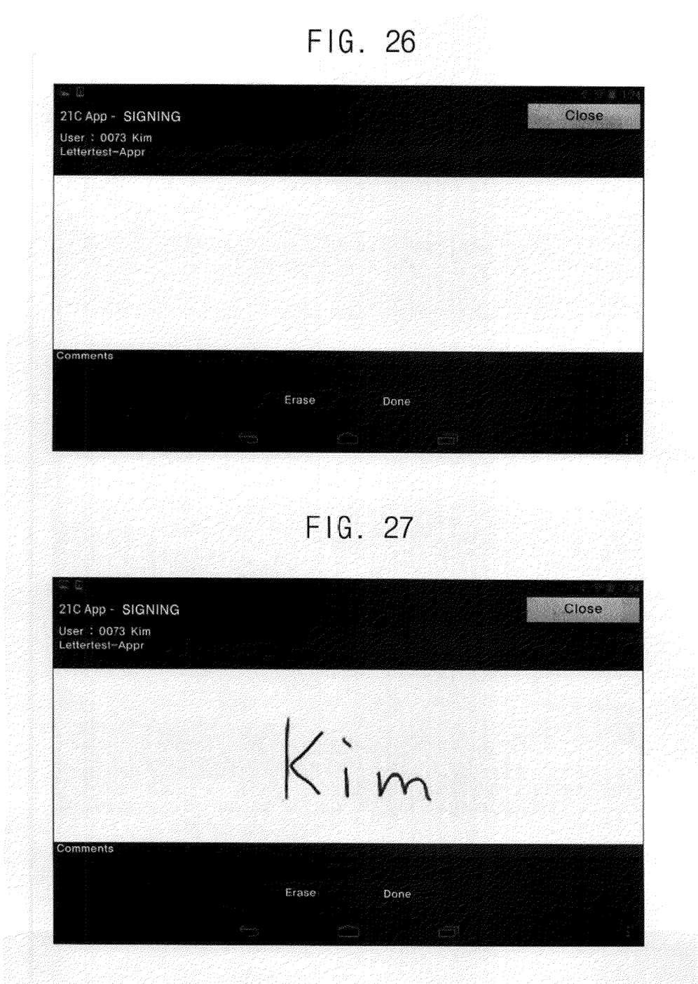

When the approve button is touched, the electronic approval program established in the approver's mobile device 500 may display the signature input window (SIWN) (S454). For example, the signature input window may be displayed as illustrated in FIG. 26.

FIG. 26 is a diagram illustrating a signature input window that is displayed on an approver's mobile device for receiving a direct signature of an approver.

Referring to FIG. 26, the size of the signature input window may be determined depending on the size of the touch screen of the approver's mobile device 500. The size of the signature input window may increase as the size of the touch screen increases. The approver may draw the direct signature in the signature input window using a stylus pen, etc. Also the finger of the approver and so on may be used to input the direct signature of the approver.

Referring to FIGS. 21A and 21B, the electronic approval program established in the approver's mobile device 500 may check whether the direct signature is drawn by the approver (S456) through the displayed signature input window as illustrated in FIG. 26. For example, the direct signature may be as illustrated in FIG. 27.

FIG. 27 is a diagram illustrating an example of a direct signature drawn by an approver.

Referring to FIG. 27, after drawing the direct signature, the approver may touch the erase button to input a new signature. When the done button or the completion button is touched the drawn signature may be provided as the direct signature as the approval of the corresponding letter approval item. The approver may touch the cancel button to cancel the drawing operation.

Referring to FIGS. 21A and 21B, the electronic approval program established in the approver's mobile device 500 may generate the signature image from the drawn signature using graphic device interface (GDI) and temporarily store the generated signature image (S458).

The electronic approval program established in the approver's mobile device 500 may check whether the erase button or the done button is touched (S460). When the erase button is touched, the stored signature image is erased (S462) and the process returns to the step 454. Also the displayed image on the signature input window is erased. When the done button is touched, the electronic approval program established in the approver's mobile device 500 may convert the signature image to a file (S468) and store the file. For example, the signature image may be converted to a binary file.

The electronic approval program established in the approver's mobile device 500 may transmit the approval completion information and the signature image file to the W/A server 300 (S466). The approval completion information may include the approval comments, the approval log, etc. The approval log may include an identifier, a serial number and an internet protocol (IP) address of the approver's mobile device 500.

The electronic approval program established in the approver's mobile device 500 may delete the signature image file (S468) after the signature image file is transmitted to the W/A server 300. The electronic approval program established in the approver's mobile device 500 may display the approval completion information (S470). The displayed approval completion information may include the approval type, the receipt time, the creator, etc.

When the W/A server 300 receive the approval completion information from the approver's mobile device 500, the W/A server 300 may transmit the approval completion information to the DB server 200 (S472). The DB server 200 may store the approval completion information, the signature image file and the completed approval process (S474).

The processes of performing the approval of the letter approval item in the approver's mobile device 500 have been described with reference to FIGS. 21A through 27. The electronic approval program established in the approver's mobile device 500 may further provide the function of checking the list of the letter approval items completed by the approver.

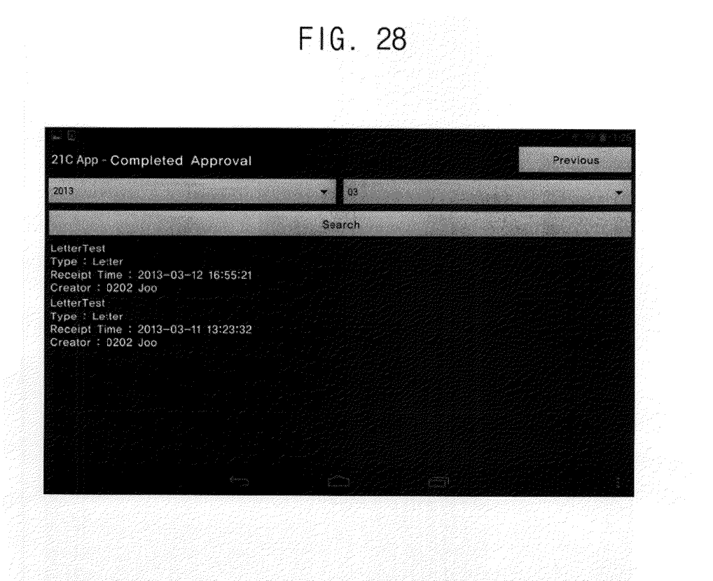

FIG. 28 is diagram illustrating a completed approval items displayed on an approver's mobile device.

Referring to FIG. 28, the completed approval items may include the title, the approval type, receipt time and the creator of each item. Through the information displayed on such completed approval items, the approver may check and manage the approval cases.

Hereinafter, examples of the program codes corresponding to the steps 454 through 466 of FIG. 21B are described.

The program codes for describing an example of custom control program (SignView.java) for direct signature according to example embodiments are as follows.

```
      =================================================
      public class signView extends View {
              //Signature Object Definition
              public Paint signPaint;
        public Bitmap signBitmap;
        public Canvas signCanvas;
              //Signature Object Setting
        public signView(Context context, AttributeSet attrs) {
            super(context, attrs);
                  signBitmap =
                  Bitmap.createBitmap( App_21C.dWidth,
App_21C.dHeight, Bitmap.Config.ARGB_8888); // Region Size
                  signCanvas = new Canvas(signBitmap);
              signPath = new Path( );
              ...
                  ...
                  signPaint = new Paint( );
                  signPaint.setColor(Color.BLACK);
                  ...
                  ...
        }
              // Signature Viewing
        protected void onDraw(Canvas canvas) {
            canvas.drawColor(Color.WHITE);
            canvas.drawBitmap(signBitmap, 0, 0, signBitmapPaint);
            canvas.drawPath(signPath, signPaint);
              }
                  ...
                  ...
        // Touch Start
        private void touch_start(float x, float y) {
            signPath.reset( );
            signPath.moveTo(x, y);
            signX = x;
            signY = y;
        }
        // When Move After Touch
        private void touch_move(float x, float y) {
            float dx = Math.abs(x − signX);
            float dy = Math.abs(y − signY);
            if (dx >= TOUCH_TOLERANCE ||
            dy >= TOUCH_TOLERANCE) {
              signPath.quadTo(signX, signY, (x + signX) / 2,
              (y + signY) / 2);
              signX = x;
              signY = y;
            }
        }
              // Touch_up and Drawing
        private void touch_up( ) {
            signPath.lineTo(signX, signY);
            signCanvas.drawPath(signPath, signPaint);
            signPath.reset( );
        }
        @Override
        public boolean onTouchEvent(MotionEvent event) {
            float x = event.getX( );
            float y = event.getY( );
            switch (event.getAction( )) {
            case MotionEvent.ACTION_DOWN:
              touch_start(x, y);
              invalidate( );
              break;
            case MotionEvent.ACTION_MOVE:
              touch_move(x, y);
              invalidate( );
              break;
            case MotionEvent.ACTION_UP:
              touch_up( );
              invalidate( );
              break;
      }
      return true;
  }
}
=================================================
```

The program codes for describing an example of custom control program (peams_sign.xml) for design of the signature input window according to example embodiments are as follows.

```
======================================================
<?xml version=“1.0” encoding=“utf-8”?>
<LinearLayout xmlns:android=“http://schemas.android.com/apk/res/
android”
      android:orientation=“vertical”
      android:layout_width=“fill_parent”
      android:layout_height=“fill_parent”
      >
    ...
    ...
    <LinearLayout
        android:id=“@+id/linearLayout2”
        android:layout_width=“match_parent”
        android:layout_height=“0dp”
        android:layout_weight=“0.17”
        android:orientation=“vertical” >
    <dk.App_21C.signView
          android:id=“@+id/signView”
          android:layout_width=“match_parent”
          android:layout_height=“wrap_content”
          android:background=“@FFFFFF”
          android:saveEnabled=“true”
          />
    </LinearLayout>
        ...
        ...
</LinearLayout>
======================================================
```

The program codes for describing an example of a program (PeamsDeci_Sign.java) corresponding to real signature class according to example embodiments are as follows.

```
      ============================================================
      private signView sV; // signView to be drawn
            public class PeamsDeci_Sign extends Activity implements {
                @Override
          public void onCreate(Bundle savedInstanceState) {
              super.onCreate(savedInstanceState);
                ...
                ...
                sV = (signView)findViewById(R.id.peamsdeci_sign_signView);
                ...
                ...
                }
                ...
                ...
                //Signature Store
                private void saveView(View view) {
                      Bitmap b = Bitmap.createBitmap(view.getWidth( ),
view.getHeight( ),
                    Bitmap.Config.ARGB_8888);
                Canvas c = new Canvas(b);
              view.draw(c);
              FileOutputStream fos = null;
              //Resizing
              Bitmap resizedbitmap;
              resizedbitmap=Bitmap.createScaledBitmap(b, view.getWidth( ),
view.getHeight( ), true);
                    String name = “mobile_sign.jpg”;//Signature File Insertion
                        //Signature Store
                File imgFile = new File(getFilesDir( ).getAbsolutePath( ),
name);//
              fos = new FileOutputStream(imgFile);
              if (fos != null) {
                    resizedbitmap.compress(Bitmap.CompressFormat.JPEG, 100, fos);
                    fos.close( );
              }
              }
              ...
              ...
              //Signature Transmit
      private void UploadView(View view) {
              {
                // Signature Store Location
                String mFilePath =
getFilesDir( ).getAbsolutePath( )+“/mobile_sign.jpg”;
                //Approval Information and Signature Upload
HttpFileUpload(“http://URL/mobile/PEAMS_DECI_SIGN_WITHLOG.ashx?u_id=“ +
URLEncoder.encode(myApp.encryption(USER_CODE), “euc-kr”)+
“&deci_doccode=”+URLEncoder.encode(myApp.encryption(DECI_DOCCODE), “euc-kr”)+
“&deci_kubun=”+URLEncoder.encode(myApp.encryption(DECI_KUBUN), “euc-kr”)+
“&deci_sign_use=”+URLEncoder.encode(myApp.encryption(“1”), “euc-kr”)+
“&deci_opinion=”+URLEncoder.encode(myApp.encryption(DECI_OPINION), “euc-kr”) +
“&deci_log=”+URLEncoder.encode(myApp.encryption(DECI_LOG), “euc-kr”) +“”
                            , “” , mFilePath,“peams_user” );
                //
              }
              // Transmission Module
      private void HttpFileUpload(String urlString , String params, String fileName,
String id) {
          try{
            mFileInputStream = new FileInputStream(fileName);
            connectUrl = new URL(urlString);
            HttpURLConnection conn =
(HttpURLConnection)connectUrl.openConnection( );
            conn.setDoInput(true);
            conn.setDoOutput(true);
            conn.setUseCaches(false);
            conn.setRequestMethod(“POST”);
            conn.setRequestProperty(“Connection”, “Keep-Alive”);
            conn.setRequestProperty(“Content-Type”,
“multipart/form-data;boundary=” + boundary);
            DataOutputStream dos = new
DataOutputStream( conn.getOutputStream( )) ;
            dos.writeBytes(twoHyphens + boundary + lineEnd);
dos.writeBytes(“Content-Disposition:form-data;name=\“uploadedfile\”;filename
=\“” + fileName + “\”” + lineEnd);
            dos.writeBytes(lineEnd);
            int bytesAvailable = mFileInputStream.available( );
            int maxBufferSize = 1024;
            int bufferSize = Math.min(bytesAvailable, maxBufferSize);
            byte[ ] buffer = new byte[bufferSize];
            int bytesRead = mFileInputStream.read( buffer , 0 , bufferSize);
            while(bytesRead > 0 ){
                dos.write(buffer , 0 , bufferSize);
                bytesAvailable = mFileInputStream.available( );
                bufferSize = Math.min(bytesAvailable, maxBufferSize);
                bytesRead = mFileInputStream.read(buffer,0,bufferSize);
            }
            dos.writeBytes(lineEnd);
            dos.writeBytes(twoHyphens + boundary + twoHyphens + lineEnd);
            mFileInputStream.close( );
            dos.flush( );
            int ch;
            InputStream is =conn.getInputStream( );
            StringBuffer b = new StringBuffer( );
            while((ch = is.read( )) != −1 ){
                b.append((char)ch);
            }
          String s = b.toString( );
            dos.close( );
          }catch(Exception e)
          {
          }
          finally
          {
                        // Signature File Delete After Completion
                          File file = new File(fileName);
              if(file.exists( ))
              {
            file.delete( );
                }
          }
      }
      }
    ============================================================
```

As described above, according to example embodiments, the approver may draw his or her signature directly in the signature input window, the drawn signature image may be converted to the binary file to be transmitted with the approval information, and thus authenticity of signature may be secured. The approver using the mobile device may touch a particular approval item in the approval item list displayed on the mobile device, and check the detailed information of the touched approval item through the display window of the mobile device. The approver may touch the approve button to load the signature input window after checking the contents of the detailed information.

The approver draws the direct signature in the signature input window in person, and the drawn signature is converted to the signature image by the GDI. When the approver touches the completion button after the direct signature, the signature image is stored as a file and the signature image file and the approval information are transmitted to the W/A server. After the transmission, the signature image stored in the mobile device may be deleted.

The W/A server stores the transmitted signature image file and the approval information, and the W/A server processes the stored data. The signature image file may not be stored in the W/A server and may be stored in the DB server directly during the uploaded state, thereby securing authenticity of signature.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of performing electronic approval processes, comprising:
creating a letter approval item including an approval document in an approval requester's personal computer (PC), the approval document including a signable region;
requesting an approval of the letter approval item by transmitting the letter approval item from the approval requester's PC to a database server;
notifying existence of the letter approval item by providing a mobile-based approval item including the letter approval item from the database server to a web/application server;
transmitting the mobile-based approval item from the web/application server to an approver's mobile device when the approver's mobile device asks existence of any approval item to the web/application server;
performing the approval of the letter approval item in the approver's mobile device in response to a direct signature of an approver;
transmitting a signature image from the approver's mobile device to the web/application server, the signature image being created in the approver's mobile device by the direct signature of the approver; and
generating a final approval document in the web/application server by inserting the signature image in the signable region of the approval document.

2. The method of claim 1, wherein the approver draws the direct signature on the approver's mobile device to create the signature image and the approver's mobile device converts the signature image to a binary file to transmit the binary file to the web/application server.

3. The method of claim 1, wherein creating the letter approval item includes:
inputting an approval line, a receiver and contents for the letter approval item;
attaching files of the letter approval item; and
displaying a letter summary by extracting the letter summary from a letter file of the letter approval item.

4. The method of claim 3, wherein the letter summary does not include a signature and includes an unsigned page number and a signed page number.

5. The method of claim 1, wherein performing the approval of the letter approval item in the approver's mobile device includes:
requesting the letter approval item from the approver's mobile device to the web/application server and receiving the mobile-based approval item from the web/application server;
notifying existence of the letter approval item by displaying an electronic approval widget on the approver's mobile device;
displaying detailed approval information of the letter approval item on the approver's mobile device in response to a selection of the letter approval item;
requesting a letter preview from the approver's mobile device to the web/application server in response to a request of the approver;
requesting the letter preview from the web/application server to the database server;
providing binary data of a letter file and a sample signature from the database server to the web/application server;
constructing a letter preview image based on the binary data of the letter file and the sample signature in the web/application server and providing the letter preview image to the approver's mobile device;
displaying the letter preview image on the approver's mobile device; and
temporarily storing comments when the comments are input through the approver's mobile device.

6. The method of claim 5, wherein performing the approval of the letter approval item in the approver's mobile device further includes:
displaying a signature input window in response to a touch of an approve button;
when the direct signature is drawn on the signature input window by the approver, generating a signature image in response to the drawn direct signature using a graphic device interface and temporarily storing the signature image;
converting the signature image to a file in response to a touch of a completion button; and
transmitting the comments and the file of the signature image from the approver's mobile device to the web/application server.

7. The method of claim 6, wherein the signature image is converted to a binary file and the binary file is stored in the approver's mobile device.

8. A system of performing electronic approval processes, comprising:
an approval requester's personal computer (PC) configured to create a letter approval item including an approval document and configure to request an approval of the letter approval item, the approval document including a signable region;
a database server configured to store the letter approval item transmitted from the approval requester's PC;
a web/application server configured to receive a mobile-based approval item including the letter approval item from the database server; and
an approver's mobile device configured to receive the mobile-based approval item from the web/application server, configured to perform the approval of the letter approval item in the approver's mobile device in response to a direct signature of an approver, and configured to transmit comments and a signature image to the web/application server, the signature image being created in the approver's mobile device by the direct signature of the approver.

9. The method of claim 8, wherein the web/application server is configured to transmit the mobile-based approval item to the approver's mobile device when the approver's mobile device asks existence of any approval item to the web/application server, and configured to generate a final approval document by inserting the signature image in the signable region of the approval document.

10. The system of claim 8, wherein the approver draws the direct signature on the approver's mobile device to create the signature image and the approver's mobile device converts the signature image to a binary file to transmit the binary file to the web/application server.

11. The system of claim 8, further comprising:
an approver's PC configured to receive a PC-based approval item including the letter approval item from the database server, configured to perform the approval of the letter approval item in the approver's PC in response to the direct signature of the approver, and configured to transmit comments and a signature image to the database server, the signature image being created in the approver's computer by the direct signature of the approver.

12. The system of claim 8, wherein the approver's mobile device includes Galaxy Note 3, Galaxy Note 8 or Galaxy Note 10.1.

13. A computer-readable storage medium storing an electronic approval program, the electronic approval program comprising processes of:
creating a letter approval item including an approval document in an approval requester's personal computer (PC), the approval document including a signable region;
requesting an approval of the letter approval item by transmitting the letter approval item from the approval requester's PC to a database server;
notifying existence of the letter approval item by providing a mobile-based approval item including the letter approval item from the database server to a web/application server;
transmitting the mobile-based approval item from the web/application server to an approver's mobile device when the approver's mobile device asks existence of any approval item to the web/application server;
performing the approval of the letter approval item in the approver's mobile device in response to a direct signature of an approver;
transmitting a signature image from the approver's mobile device to the web/application server, the signature image being created in the approver's mobile device by the direct signature of the approver; and
generating a final approval document in the web/application server by inserting the signature image in the signable region of the approval document.
